(19) United States
(12) Patent Application Publication
(10) Pub. No.: US 2025/0091011 A1
(43) Pub. Date: Mar. 20, 2025

(54) DESALINATION AND COOLING SYSTEM INTEGRATING AIR GAP MEMBRANE DISTILLATION AND EJECTOR COOLING CYCLE

(71) Applicant: KING FAHD UNIVERSITY OF PETROLEUM AND MINERALS, Dhahran (SA)

(72) Inventors: Dahiru Umar LAWAL, Dhahran (SA); Binash IMTEYAZ, Dhahran (SA); Turki Nabieh BAROUD, Dhahran (SA); Umer ZAHID, Dhahran (SA)

(73) Assignee: KING FAHD UNIVERSITY OF PETROLEUM AND MINERALS, Dhahran (SA)

(21) Appl. No.: 18/469,288

(22) Filed: Sep. 18, 2023

(51) Int. Cl. B01D 61/36; C02F 1/44; C02F 103/08; F25B 1/06

(52) U.S. Cl. CPC B01D 61/368; B01D 61/3641; B01D 61/366; C02F 1/447; F25B 1/06; B01D 2313/221; B01D 2313/367; C02F 2103/08; C02F 2201/009; C02F 2301/08; C02F 2303/10

(57) ABSTRACT

A desalination and cooling system integrating an Ejector Cooling Cycle (ECC) and an Air Gap Membrane Distillation (AGMD) system. The ECC system includes a generator, an evaporator, an ejector, and a condenser. The generator produces a primary flow of refrigerant, the evaporator provides cooling and a secondary flow of the refrigerant, and the ejector combines these flows to generate a super-heated stream of the refrigerant, which the condenser cools. The AGMD system, comprising a feed chamber, a coolant chamber, an air gap chamber, and a membrane with pores, allows water vapors from a hot stream to pass from the feed chamber to the air gap chamber of the AGMD system. The ECC and AGMD systems are connected at the condenser, where the super-heated stream of the refrigerant heats the cold stream to produce the hot stream, facilitating efficient desalination and cooling.

### CROSS REFERENCE TO RELATED APPLICATIONS

Aspects of the present disclosure are described in Applicant's co-pending patent applications titled “DESALINATION AND COOLING SYSTEM INTEGRATING PERMEATE GAP MEMBRANE DISTILLATION AND EJECTOR COOLING CYCLE” (Attorney Docket No.: 548519US), “DESALINATION AND COOLING SYSTEM INTEGRATING DIRECT CONTACT MEMBRANE DISTILLATION AND EJECTOR COOLING CYCLE” (Attorney Docket No.: 548520US), “DESALINATION AND COOLING SYSTEM INTEGRATING VACUUM MEMBRANE DISTILLATION AND EJECTOR COOLING CYCLE” (Attorney Docket No.: 548521US), and “DESALINATION AND COOLING SYSTEM INTEGRATING SWEEPING GAS MEMBRANE DISTILLATION AND EJECTOR COOLING CYCLE” (Attorney Docket No.: 548524US), all of which are incorporated herein by reference in their entirety.

### BACKGROUND

### Technical Field

The present disclosure is directed to the field of desalination and cooling technologies. More specifically, the present disclosure relates to a desalination and cooling system integrating an Air Gap Membrane Distillation (AGMD) system and an Ejector Cooling Cycle (ECC) system for efficient concurrent and simultaneous desalination and cooling.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Water scarcity is one of the most pressing challenges of our time, driven by factors such as population growth, urbanization, and climate change. As freshwater resources become increasingly scarce, societies around the world are seeking sustainable and efficient methods to secure reliable water supplies. Desalination, which is the process of removing salts and other minerals from sea water or brackish water, has emerged as a critical technology to augment freshwater resources.

However, traditional desalination techniques such as reverse osmosis and thermal distillation often come with substantial energy cost, significant environmental impact, and in some cases, produce brine by-products that pose disposal challenges. As a result, there has been an increasing interest in developing more energy-efficient, environmentally friendly, and cost-effective desalination technologies. One promising approach is Membrane Distillation (MD), a thermal desalination process that leverages a selective membrane to separate salts and other contaminants from water.

Among various MD configurations, Air Gap Membrane Distillation (AGMD) has shown promising performance. In AGMD, the hot feed stream and the cold distillate stream are separated by a hydrophobic membrane and an air gap. The temperature difference across the membrane causes water vapor to evaporate from the feed stream, travel through the membrane pores, and condense in the air gap via the assistance of a cold wall or any other cooling component designed to condense the water vapors into liquid water, producing clean water. The larger the temperature difference between the feed and permeate sides, the higher the vapor pressure difference, leading to increased water flux across the membrane.

In addition to desalination, there is also a growing demand for energy-efficient cooling technologies. Cooling is essential for various applications, including air conditioning, refrigeration, and industrial processes. Conventional cooling technologies, such as vapor compression refrigeration, are energy-intensive and use refrigerants that can have a high global warming potential. Therefore, there is a need for more energy-efficient, environmentally friendly cooling technologies.

One such technology is Ejector Cooling Cycle (ECC), which is a type of refrigeration cycle that uses a jet of vapor to entrain and compress additional vapor, eliminating the need for a mechanical compressor. The ECC is less energy-intensive compared to traditional vapor compression refrigeration and can operate with a variety of refrigerants, including environmentally friendly options. However, like all refrigeration cycles, ECC produces waste heat that is typically released into the environment.

Therefore, the search for efficient, sustainable, and cost-effective desalination technology as well as cooling technology is a pressing issue in the context of water scarcity and energy efficiency. There are existing technologies in both areas, each with its strengths and weaknesses. The challenge lies in overcoming their limitations and finding innovative ways to enhance their performance and make them more suitable for widespread application.

WO2013151498A1 discloses a vacuum air gap membrane distillation system including a thermo-compressor that is used to produce the vacuum required for the system. The thermo-compressor can be an injector, ejector, steam ejector, steam injector, or eductor-jet pump.

US20220333868A1 discloses an evaporative cooling system including an evaporative cooler liquid-to-air membrane energy exchanger.

U.S. Ser. No. 11/666,862B2 discloses an air gap membrane distillation apparatus including a housing and an impeller.

Koirala et al. (“A Review on Process and Practices in Operation and Design Modification of Ejectors”) reviews various applications of ejectors and shows an ejector-based membrane distillation process in which water vapors generated by membrane distillation is used as a secondary flow of the refrigerant for the ejector. There is no ECC or AGMD present in the aforementioned study.

Koirala et al. (“Experimental investigation of an air gap membrane distillation unit with double-sided cooling channel”) discloses a double-stage air gap membrane distillation (AGMD) system. The aforementioned reference does not teach us about any ejector or ECC.

Each of the aforementioned references suffers from one or more drawbacks hindering their adoption. Accordingly, it is one object of the present disclosure to provide a desalination and cooling system integrating AGMD and ECC to enhance the energy efficiency, environmental performance, and cost-effectiveness of desalination and cooling technologies.

### SUMMARY

In an exemplary embodiment, a desalination and cooling system is provided. The desalination and cooling system includes an ejector cooling cycle (ECC) system. The ECC system includes a generator configured to generate a primary flow of a refrigerant. The ECC system also includes an evaporator configured to provide cooling and provide a secondary flow of the refrigerant. The ECC system further includes an ejector configured for the primary flow and the secondary flow to pass through to obtain a super-heated stream of the refrigerant. The ECC system further includes a condenser configured to cool the super-heated stream of the refrigerant. The desalination and cooling system also includes an air gap membrane distillation (AGMD) system. The AGMD system includes a feed chamber configured to receive a hot stream comprising water. The AGMD system also includes a coolant chamber configured to receive a cold stream comprising water. The AGMD system further includes an air gap chamber disposed between the feed chamber and the coolant chamber. The AGMD system further includes a membrane disposed between the feed chamber and the air gap chamber, the membrane comprising a plurality of pores configured to allow water vapors originating from the hot stream to pass from the feed chamber through the membrane to the air gap chamber. The ECC system and the AGMD system are connected at the condenser so that the cold stream is heated by the super-heated stream of the refrigerant at the condenser to produce the hot stream.

In some embodiments, the coolant chamber and the air gap chamber are configured to allow heat exchange so that the coolant chamber pre-heats the cold stream.

In some embodiments, an outlet of the evaporator is connected to an inlet of the coolant chamber so that the evaporator is configured to provide cooling for the cold stream before the cold stream enters the coolant chamber.

In some embodiments, the ECC system further includes a heater that is configured to provide heat for the generator to generate the primary flow of the refrigerant.

In some embodiments, the heater is configured to further heat the hot stream after the condenser and before the feed chamber.

In some embodiments, the AGMD system further includes a cold wall disposed between the coolant chamber and the air gap chamber.

In some embodiments, the ECC system further includes a heater that is configured to further heat the super-heated stream of the refrigerant before the super-heated stream of the refrigerant enters the condenser.

In some embodiments, the AGMD system is a multi-effect distillation system.

In some embodiments, the desalination and cooling system further includes an external chiller that is configured to cool the cold stream before the cold stream enters the coolant chamber.

In some embodiments, the ECC system further includes a solar collector that is configured to provide heat for the generator to generate the primary flow of the refrigerant.

In another exemplary embodiment, a desalination and cooling system is provided. The desalination and cooling system includes an ejector cooling cycle (ECC) system. The ECC system includes a generator configured to generate a primary flow of a refrigerant. The ECC system also includes an evaporator configured to provide cooling and provide a secondary flow of the refrigerant. The ECC system further includes an ejector configured for the primary flow and the secondary flow to pass through to obtain a super-heated stream of the refrigerant. The ECC system further includes a condenser configured to cool the super-heated stream of the refrigerant, the condenser comprising a wall separating a hot medium compartment and a cold medium compartment, the hot medium compartment configured to receive the super-heated stream of the refrigerant. The desalination and cooling system also includes an air gap membrane distillation (AGMD) system. The AGMD system includes a coolant chamber configured to receive a feed stream comprising water. The AGMD system has the cold medium compartment of the condenser of the ECC system configured to receive the feed stream from the coolant chamber. The AGMD system also includes an air gap chamber disposed between the cold medium compartment and the coolant chamber. The AGMD system further includes a membrane disposed between the cold medium compartment and the air gap chamber, the membrane comprising a plurality of pores configured to allow water vapors to pass from the cold medium compartment through the membrane to the air gap chamber. The ECC system and the AGMD system are connected at the condenser so that the feed stream, in the cold medium compartment of the condenser, is heated by the super-heated stream of the refrigerant to generate the water vapors.

In some embodiments, the desalination and cooling system further includes an enclosure that houses the hot medium compartment, the cold medium compartment, the membrane, the air gap chamber, and the coolant chamber.

In some embodiments, the hot medium compartment, the cold medium compartment, the membrane, the air gap chamber, and the coolant chamber are arranged in succession in the enclosure.

In some embodiments, the generator, the ejector and the condenser are configured to define a power cycle of the ECC system. Further, the evaporator, the ejector and the condenser are configured to define a refrigeration cycle of the ECC system.

In some embodiments, the coolant chamber and the air gap chamber are configured to allow heat exchange so that the coolant chamber pre-heats the feed stream.

In some embodiments, an outlet of the evaporator is connected to an inlet of the coolant chamber so that the evaporator is configured to provide cooling for the feed stream before the feed stream enters the coolant chamber.

In some embodiments, the ECC system further includes a heater that is configured to provide heat for the generator to generate the primary flow of the refrigerant.

In some embodiments, the AGMD system further includes a cold wall disposed between the coolant chamber and the air gap chamber.

In some embodiments, the ECC system further includes a heater that is configured to further heat the super-heated stream of the refrigerant before the super-heated stream of the refrigerant enters the condenser.

In some embodiments, the coolant chamber, the air gap chamber, the membrane, the cold medium compartment and the hot medium compartment are cylindrical and concentrical and are arranged in succession along a radial direction.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a desalination and cooling system integrating an ejector cooling cycle (ECC) system and an air gap membrane distillation (AGMD) system, according to certain embodiments;

FIG. 2 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a condenser of the ECC system heats the feed stream, according to certain embodiments;

FIG. 3 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and an evaporator of the ECC system provides a cooling effect which is partly utilized for cooling the feed stream, according to certain embodiments;

FIG. 4 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and an external chiller cools the feed stream, according to certain embodiments;

FIG. 5 is a schematic diagram of a desalination and cooling system having a multi-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a condenser of the ECC system heats the feed stream, according to certain embodiments;

FIG. 6 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a heater, inlet to a generator of the ECC system, heats the feed stream, according to certain embodiments;

FIG. 7 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a heater, inlet to a generator of the ECC system, heats the feed stream, and an evaporator of the ECC system provides a cooling effect which is partly utilized for cooling the feed stream, according to certain embodiments;

FIG. 8 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a heater, inlet to a generator of the ECC system, heats the feed stream, and an external chiller cools the feed stream, according to certain embodiments;

FIG. 9 is a schematic diagram of a desalination and cooling system having a multi-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a heater, inlet to a generator of the ECC system, heats the feed stream, according to certain embodiments;

FIG. 10 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a heater, outlet to a generator of the ECC system, heats the feed stream, according to certain embodiments;

FIG. 11 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a heater, outlet to a generator of the ECC system, heats the feed stream, and an evaporator of the ECC system provides a cooling effect which is partly utilized for cooling the feed stream, according to certain embodiments;

FIG. 12 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a heater, outlet to a generator of the ECC system, heats the feed stream, and an external chiller cools the feed stream, according to certain embodiments;

FIG. 13 is a schematic diagram of a desalination and cooling system having a multi-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a heater, outlet to a generator of the ECC system, heats the feed stream, according to certain embodiments;

FIG. 14 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a super-heated stream of refrigerant exiting an ejector through a heater of the ECC system, heats the feed stream, according to certain embodiments;

FIG. 15 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a super-heated stream of refrigerant exiting an ejector through a heater of the ECC system, heats the feed stream, and an evaporator of the ECC system provides a cooling effect which is partly utilized for cooling the feed stream, according to certain embodiments;

FIG. 16 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, a super-heated stream of refrigerant exiting an ejector through a heater of the ECC system, heats the feed stream, and an external chiller cools the feed stream, according to certain embodiments;

FIG. 17 is a schematic diagram of a desalination and cooling system having a multi-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system heats the feed stream, and a super-heated stream of refrigerant exiting an ejector through a heater of the ECC system, heats the feed stream, according to certain embodiments;

FIG. 18 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a super-heated stream of refrigerant exiting an ejector through a heater of the ECC system, heats the feed stream, according to certain embodiments;

FIG. 19 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a super-heated stream of refrigerant exiting an ejector through a heater of the ECC system, heats the feed stream, and an evaporator of the ECC system provides a cooling effect which is partly utilized for cooling the feed stream, according to certain embodiments;

FIG. 20 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a super-heated stream of refrigerant exiting an ejector through a heater of the ECC system, heats the feed stream, and an external chiller cools the feed stream, according to certain embodiments;

FIG. 21 is a schematic diagram of a desalination and cooling system having a multi-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a super-heated stream of refrigerant exiting an ejector through a heater of the ECC system, heats the feed stream, according to certain embodiments;

FIG. 22 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a heat exchange from direct contact between a condenser of the ECC system and a feed chamber of the AGMD system heats the feed stream, according to certain embodiments;

FIG. 23A is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, and a condenser of the ECC system having a hot medium compartment and a cold medium compartment, and the cold medium compartment receives the feed stream from the coolant chamber and heats the feed stream in the AGMD system, according to certain embodiments;

FIG. 23B is a cross-section diagram of the AGMD system of FIG. 23A, according to certain embodiments;

FIG. 23C is a cross-section diagram of the AGMD system of FIG. 23A, according to alternate embodiments;

FIG. 24 is a schematic diagram of a desalination and cooling system having a single-effect configuration, and integrating an ejector cooling cycle (ECC) system and an air gap membrane distillation (AGMD) system, where a feed stream to be treated is fluidly connected in an open loop, a coolant chamber of the AGMD system pre-heats the feed stream, a condenser of the ECC system having a hot medium compartment and a cold medium compartment, the cold medium compartment receives the feed stream from the coolant chamber and heats the feed stream in the AGMD system, and an evaporator of the ECC system provides a cooling effect which is utilized for cooling the feed stream in the AGMD system, according to certain embodiments;

FIG. 25A is a graph representing gained output ratio (GOR) performance of the desalination and cooling system of FIG. 1 at different temperatures of a generator of the ECC system therein;

FIG. 25B is a graph representing energy utilization factor (EUF) performance of the desalination and cooling system of FIG. 1 at different temperatures of a generator of the ECC system therein;

FIG. 25C is a graph representing freshwater productivity performance of the desalination and cooling system of FIG. 1 at different temperatures of a generator of the ECC system therein;

FIG. 25D is a graph representing cooling effect performance of the desalination and cooling system of FIG. 1 at different temperatures of a generator of the ECC system therein;

FIG. 26A is a graph representing gained output ratio (GOR) performance of the desalination and cooling system of FIG. 1 at different temperatures of an evaporator of the ECC system therein;

FIG. 26B is a graph representing energy utilization factor (EUF) performance of the desalination and cooling system of FIG. 1 at different temperatures of an evaporator of the ECC system therein;

FIG. 26C is a graph representing freshwater productivity performance of the desalination and cooling system of FIG. 1 at different temperatures of an evaporator of the ECC system therein;

FIG. 26D is a graph representing cooling effect performance of the desalination and cooling system of FIG. 1 at different temperatures of an evaporator of the ECC system therein;

FIG. 27A is a graph representing gained output ratio (GOR) performance of the desalination and cooling system of FIG. 1 at different temperatures of a condenser of the ECC system therein;

FIG. 27B is a graph representing energy utilization factor (EUF) performance of the desalination and cooling system of FIG. 1 at different temperatures of a condenser of the ECC system therein;

FIG. 27C is a graph representing freshwater productivity performance of the desalination and cooling system of FIG. 1 at different temperatures of a condenser of the ECC system therein.

FIG. 27D is a graph representing cooling effect performance of the desalination and cooling system of FIG. 1 at different temperatures of a condenser of the ECC system therein;

FIG. 28A is a graph representing gained output ratio (GOR) performance of the desalination and cooling system of FIG. 1 at different module length of the AGMD system;

FIG. 28B is a graph representing energy utilization factor (EUF) performance of the desalination and cooling system of FIG. 1 at different module length of the AGMD system;

FIG. 28C is a graph representing freshwater productivity performance of the desalination and cooling system of FIG. 1 at different module length of the AGMD system;

FIG. 28D is a graph representing cooling effect performance of the desalination and cooling system of FIG. 1 at different module length of the AGMD system;

FIG. 29A is a graph representing gained output ratio (GOR) performance of the desalination and cooling system of FIG. 1 at different temperatures of feed stream therein;

FIG. 29B is a graph representing energy utilization factor (EUF) performance of the desalination and cooling system of FIG. 1 at different temperatures of feed stream therein;

FIG. 29C is a graph representing freshwater productivity performance of the desalination and cooling system of FIG. 1 at different temperatures of feed stream therein;

FIG. 29D is a graph representing cooling effect performance of the desalination and cooling system of FIG. 1 at different temperatures of feed stream therein;

FIG. 30A is a graph representing gained output ratio (GOR) performance of the desalination and cooling system of FIG. 1 at different air gap thicknesses of an air gap chamber of the AGMD system therein;

FIG. 30B is a graph representing energy utilization factor (EUF) performance of the desalination and cooling system of FIG. 1 at different air gap thicknesses of an air gap chamber of the AGMD system therein;

FIG. 30C is a graph representing freshwater productivity performance of the desalination and cooling system of FIG. 1 at different air gap thicknesses of an air gap chamber of the AGMD system therein;

FIG. 30D is a graph representing cooling effect performance of the desalination and cooling system of FIG. 1 at different air gap thicknesses of an air gap chamber of the AGMD system therein;

FIG. 31A is a graph representing gained output ratio (GOR) performance of the desalination and cooling system of FIG. 1 at different flow rates of feed stream therein;

FIG. 31B is a graph representing energy utilization factor (EUF) performance of the desalination and cooling system of FIG. 1 at different flow rates of feed stream therein;

FIG. 31C is a graph representing freshwater productivity performance of the desalination and cooling system of FIG. 1 at different flow rates of feed stream therein; and

FIG. 31D is a graph representing cooling effect performance of the desalination and cooling system of FIG. 1 at different flow rates of feed stream therein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a desalination and cooling system which integrates an ejector cooling cycle (ECC) system and an air gap membrane distillation (AGMD) system (the desalination and cooling system is interchangeably referred to as an “integrated system” without any limitations), utilizing the waste heat from the ECC system to heat a feed stream (e.g. saline water) in the AGMD system. This innovative approach offers several benefits. First, it enhances the overall energy efficiency of the integrated system by capturing and reusing waste heat that would otherwise be lost. Second, it potentially reduces the cost of the process by combining two operations into the integrated system, saving on equipment and operational costs. Third, by leveraging cooling capabilities of the ECC system, the integrated system can also provide cooling facilities in addition to desalination, making it particularly suitable for applications in warm climates where both clean water and cooling are in high demand.

Although the desalination and cooling system, integrating the ECC system and the AGMD system, shows great promise, it also poses new challenges. The integrated system needs to be carefully designed to ensure the efficient transfer of heat from the ECC process to the AGMD process. For instance, the design considerations include configurations of feed chamber and coolant chamber in the AGMD system, the use of heat exchangers for effective heat transfer between the ECC system and AGMD system, and the control of various operating parameters. The present disclosure addresses these challenges and presents novel, improved designs for the desalination and cooling system integrating the ECC system and the AGMD system, as discussed hereinafter.

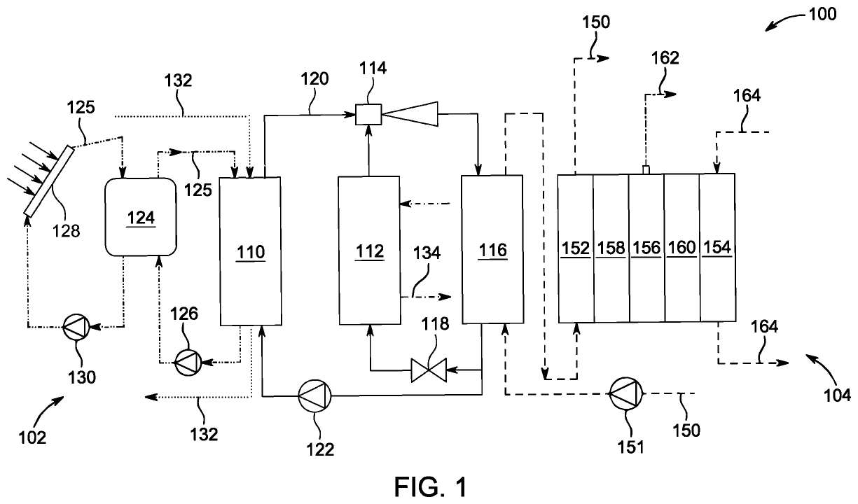

Referring to FIG. 1, illustrated is a desalination and cooling system 100 that integrates an Ejector Cooling Cycle (ECC) system 102 and an air gap Membrane Distillation (AGMD) system 104. The desalination and cooling system 100 utilizes and combines principles of thermodynamic cycles and heat and mass transfer to create a looped system that provides cooling effect via the ECC system 102 and also produces desalinated water via the AGMD system 104. In particular, the ECC system 102 is responsible for the thermal management process, and operates based on the principles of thermodynamics, utilizing a refrigerant to absorb, transfer, and release heat in a cyclic manner. On the other hand, the AGMD system 104 is responsible for the desalination process and operates based on the principles of heat and mass transfer. Thereby, the desalination and cooling system 100 of the present disclosure provides solutions for water desalination and thermal management by integrating the functionalities and leveraging the synergies of the ECC system 102 and the AGMD system 104, to enhance energy efficiency and productivity.

As illustrated, the ECC system 102 includes a generator 110, an evaporator 112, an ejector 114, a condenser 116, and a throttle valve 118. Herein, the ECC system 102 uses a refrigerant 120 (with a flow of the refrigerant 120 being shown by solid lines in FIG. 1) to perform a cooling cycle. The generator 110 is configured to generate a primary flow of the refrigerant 120. The evaporator 112 provides cooling and creates a secondary flow of the refrigerant 120. The primary and secondary flows of the refrigerant 120 pass through the ejector 114 to obtain a super-heated stream of the refrigerant 120. The condenser 116 cools the super-heated stream of the refrigerant 120. The super-heated stream of the refrigerant 120, after being cooled in the condenser 116, releases a significant amount of latent heat, which may be utilized. As shown, a first pump 122 may be placed between the condenser 116 and the generator 110, which aids in circulating the cooled refrigerant 120 from the condenser 116 back to the generator 110. Herein, the generator 110, the evaporator 112, and the condenser 116 (and also a heater and a heat exchanger as would be discussed later) may each include a heat exchanger of any suitable types which may include, but not limited to, plate heat exchangers, tube in tube heat exchangers, shell and tube heat exchangers, plate and shell heat exchangers, plate fin heat exchangers, double tube heat exchangers, adiabatic wheel heat exchangers, finned tube heat exchangers and other heat exchanger variants.

In some examples, the ECC system 102 may also include additional components. A storage tank 124 may also be part of the ECC system 102 to store a heat exchange fluid 125 (as represented by dashed-double dotted lines), such as water. A second pump 126 may be added between the generator 110 and the storage tank 124, which may facilitate circulation of the heat exchange fluid 125 between the generator 110 and the storage tank 124. In some examples, a solar collector 128, or some other renewable energy sources, may be added to the ECC system 102 for providing energy for operations thereof. Further, a third pump 130 may be added between the storage tank 124 and the solar collector 128, which may facilitate circulation of the heat exchange fluid 125 between these two components. Herein, the solar collector 128 may harness solar energy to heat the heat exchange fluid 125, which may then be stored in the storage tank 124 to be circulated to the generator 110 for heating the refrigerant 120 therein. Thereby, the solar collector 128 is configured to provide heat for the generator 110 to generate the primary flow of the refrigerant 120 in the ECC system 102.

Furthermore, in some examples, the generator 110 may utilize waste heat 132 (as represented by dotted lines) from an external source for heating the refrigerant therein. These external sources may vary depending on an application and/or a location of the operation of the ECC system 102. Some potential external sources of waste heat may include, but not limited to, industrial processes, power generation facilities, data centers, etc. The waste heat supplied to the generator 110 heats the refrigerant 120 (along with heat from the heat exchange fluid 125), causing the refrigerant 120 to evaporate and create a high-pressure gas. The remaining waste heat in the generator 110 may be exhausted out or be utilized for some other heating purposes in the desalination and cooling system 100 without any limitations.

In the ECC system 102, the generator 110, the ejector 114, and the condenser 116 are configured to define a power cycle. In the power cycle, the primary flow of the refrigerant 120 is generated in the generator 110 and then directed to the ejector 114. The primary flow of the refrigerant 120 drives the operation of the ejector 114, which also receives the secondary flow of the refrigerant 120 from the evaporator 112. The primary and secondary flows of the refrigerant 120 mix in the ejector 114 to produce the super-heated stream of the refrigerant 120, which then enters the condenser 116. The condenser 116 cools the super-heated stream of the refrigerant 120, releasing heat that is transferred to the feed stream 150 in the AGMD system 104. This heat transfer elevates the temperature of the feed stream 150, promoting the distillation process in the AGMD system 104. Moreover, in the ECC system 102, the evaporator 112, the ejector 114, and the condenser 116 are configured to define a refrigeration cycle. In the refrigeration cycle, the evaporator 112 provides cooling and generates the secondary flow of the refrigerant 120. This secondary flow is directed to the ejector 114, where it mixes with the primary flow to form the super-heated stream of the refrigerant 120. After the condensation process in the condenser 116, the refrigerant 120 flows through the throttle valve 118 and returns to the evaporator 112 to provide a cooling effect 134, completing the refrigeration cycle. The cooling effect 134 produced in the evaporator 112 may be used for cooling and air conditioning applications or other appropriate applications, and/or to cool the incoming feed stream 150 or other parts of the desalination and cooling system 100 as required. By defining separate power and refrigeration cycles within the ECC system 102, the desalination and cooling system 100 may effectively manage the heat transfer and cooling processes to enhance the overall efficiency and productivity thereof.

The AGMD system 104, on the other hand, is responsible for the actual desalination process. The desalination and cooling system 100 is configured to treat a feed stream 150 (as represented by dashed lines), which may be pumped in via a feed pump 151, and that is fluidly connected in an open loop. The AGMD system 104 includes a feed chamber 152, a coolant chamber 154, an air gap chamber 156, and a membrane 158. Herein, the feed chamber 152 receives the feed stream 150 comprising water, usually, in a heated state (and thus also referred to as hot stream or hot feed stream, without any limitations) thereof. The coolant chamber 154 receives a coolant 164, usually, in a cooled state (and thus also referred to as cold stream or cold feed stream, without any limitations). The air gap chamber 156 is disposed between the feed chamber 152 and the coolant chamber 154. The membrane 158, which includes a plurality of pores, is disposed between the feed chamber 152 and the air gap chamber 156. In some examples, the AGMD system 104 further includes a cold wall 160, in the form of a thermally conductive plate, disposed between the coolant chamber 154 and the air gap chamber 156.

Herein, the membrane 158 may include any one of a composite membrane, a nano-composite membrane, a hydrophobic membrane, an omniphobic membrane, a hydrophilic and hydrophobic composite dual layer membrane, a modified ceramic membrane, a porous ceramic membrane, a surface modified membrane, a polymer electrolyte membrane, a porous graphene membrane, or a polymeric membrane, and a contact angle of a droplet of the feed stream 150 on the membrane 158 is at least 90 degrees. The membrane 158 is hydrophobic so that surface tension prevents liquid water and salts contained in the liquid water from entering the pores of the membrane 158 while allowing water vapor to pass through.

Further, the wall 160 may be a thin metallic plate or tubes or thin polymeric plate or tubes. The wall 160 may be made of any one of composite material, carbon fibers, carbon nanotube, sapphire, any material that that are non-corrosive, cannot interact chemically with the fluid in the AGMD system 104, and have good thermal conductivity. The wall 160 may have a surface which may be flat, curved, smooth, rough, zigzagged, or any surface kind of texture.

In the AGMD system 104, the feed stream 150 in the feed chamber 152 flows over the surface of the membrane 158, where water vapor is generated at the membrane-feed water interface. The pores in the membrane 158 allow water vapors originating from the feed stream 150 to pass from the feed chamber 152 through the membrane 158 to the air gap chamber 156. Specifically, the membrane 158, with its selective permeability (liquid water impervious water vapor permeable), allows only water vapor to pass through, effectively separating the water vapor from the other contaminants present in the feed stream 150. The driving force for vapor permeation across the membrane 158 is the partial pressure difference between the two sides of the membrane 158, as created by the temperature difference between the two sides of the membrane 158. The water vapor, once in the air gap chamber 156, condenses into liquid water, by rejecting heat to the cold wall 160 (if available) and the coolant chamber 154 forming freshwater 162. The freshwater 162 may then be drained or pumped out of the air gap chamber 156. Herein, the flow of the feed stream 150 in the compartments of the AGMD system 104 may be vertical, horizontal, or inclined, without any limitations. Further, the AGMD system 104 may be any one of a spiral wound configuration, a tubular membrane configuration, a hollow fiber membrane configuration, or a flat sheet (plate and frame) membrane configuration, without any limitations.

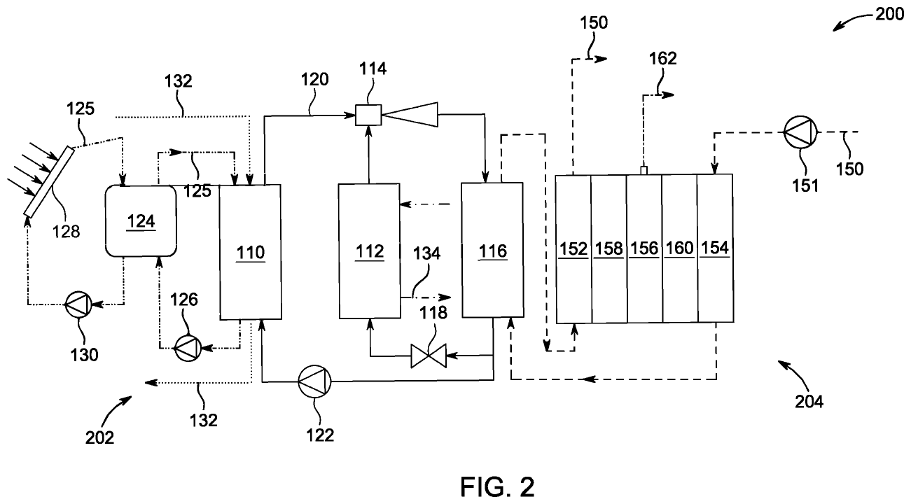

Now, specifically as illustrated in FIG. 2, the desalination and cooling system 100 of the present disclosure have the ECC system 102 and the AGMD system 104 connected at the condenser 116. In the desalination and cooling system 100, the feed stream 150 to be treated initially passes through the coolant chamber 154. Here, the feed stream 150 becomes pre-heated, simultaneously maintaining the low temperature of the cold wall 160, which in turn keeps the water in the air gap chamber 156 at a reduced temperature. Following this pre-heating stage, the feed stream 150 enters the condenser 116, allowing the feed stream 150 to be heated by the super-heated stream of the refrigerant 120 at the condenser 116. This process results in the production of the feed stream 150. In general, in the desalination and cooling system 100 of the present disclosure, heat source and heat sink to the AGMD system 104 may be completely or partially provided by the ECC system 102, which acts as a heat pump. By using the waste heat from the ECC system 102 to pre-heat the feed stream 150, the desalination and cooling system 100 improves energy utilization and maximizes the overall productivity of the desalination and cooling process. Thereby, the desalination and cooling system 100 allows for efficient desalination and cooling processes by combining the functionalities of the ECC system 102 and the AGMD system 104.

Further, as illustrated, the desalination and cooling system 100 has the feed stream 150 to be treated fluidly connected in an open loop, which may offer certain advantages in terms of operational flexibility. This open-loop configuration may facilitate the use of various water sources as the feed stream, and it allows for the easy discharge of concentrated brine or other waste products, making it well-suited for continuous, large-scale operations. Herein, the feed stream 150 may be any water source that requires desalination, such as seawater, brackish water, or even wastewater. Also, the refrigerant 120 for the ECC system 102 is selected to have appropriate thermodynamic properties, including a suitable boiling point, high latent heat, and low viscosity. The refrigerant 120, including, but not limited to, R718, R134a, R290, R12, R600, R245fa, etc. may be used in the ECC system 102 without any limitations. Further, the coolant chamber 154 of the AGMD system 104 is configured to achieve the low temperature necessary for the cold wall 160 to condense water vapors in the in the air gap chamber 156. This low temperature may be obtained from various sources of cooling load, such as ambient feed intake, an external chiller, or even a portion of the cooling effect from the ECC evaporator. For example, as shown in FIG. 1, the AGMD system 104 may utilize a coolant stream 164 which may include water containing additives or other substances that enhance its thermal properties, such as specific heat capacity or thermal conductivity, to improve the efficiency of the heat exchange process.

It may be understood that in the illustrated example of the desalination and cooling system 100 of FIG. 1, the AGMD system 104 is a single-effect distillation system; or in other words, the desalination and cooling system 100 is implemented as a single-effect desalination and cooling system; however, in other examples, the AGMD system 104 may be a multi-effect distillation system, and the corresponding desalination and cooling system 100 may be implemented as a multi-effect desalination and cooling system (as discussed later) without departing from the spirit and the scope of the present disclosure. It may be noted that in a multi-effect configuration, the number of stages depends on a difference between temperatures of the feed stream 150 and the coolant stream 164 at a final stage, which may need to be maintained between 10° C. and 20° C., and at least 10° C. Further, in present examples, in the ECC system 102, the generator 110, the evaporator 112, the condenser 116, or any other heat exchanger, may be designed as single-effect or multi-effect units, without any limitations. Similarly, in the AGMD system 104, the feed chamber 152, the coolant chamber 154, the air gap chamber 156, the membrane 158, and the cold wall 160, or any other heat exchanger, may be designed as single-effect or multi-effect units, without any limitations.

Also, it may be contemplated by a person skilled in the art that the desalination and cooling system 100 may incorporate various configurations to enhance its efficiency. For instance, in some examples, the coolant chamber 154 may receive the feed stream 150 either as pumped in or in a cooled state thereof. In some examples, the feed stream 150 is pre-heated in the coolant chamber 154 by removing heat from the cold wall 160 before entering the condenser 116 of the ECC system 102 for further heating. In other examples, the intake feed stream 150 is pre-heated in both the coolant chamber 154 and the condenser 116, and may then further heated in a heater or the like (discussed later) either by a heater entering or exiting the generator 110. Alternatively, the intake feed stream 150 may be further heated in the heater by the super-heated stream of the refrigerant 120 exiting the ejector 114. Also, in certain examples, the condenser 116 of the ECC system 102 and the feed chamber 152 of the AGMD system 104 may be designed to come into direct contact, facilitating heat exchange between the refrigerant 120 and the feed stream 150. In other examples, a portion of the cooling effect produced by the ECC system 102 may be utilized for cooling the feed stream 150 for applications in the AGMD system 104. In still other examples, external chillers (as discussed later) may be used to reduce intake temperature of the feed stream 150 to promote effective vapor condensation in the air gap chamber 156 of the AGMD system 104. Further, in certain examples, cycles of the feed stream 150 and the coolant stream 164 may be configured as open, closed, or partially open-closed based on the specific needs of the application. It may be appreciated that for open cycle/loop, the feed stream 150 exiting the AGMD system 104 is rejected, and for a closed cycle(s)/loop(s), the feed stream 150 may be recirculated together with replenished stream.

A general overview of the desalination and cooling process as per the present disclosure has been discussed thus far in consideration of the desalination and cooling system 100 of FIG. 1 as an exemplary embodiment. The present disclosure further provides various alternate configurations to the desalination and cooling system 100. These alternate configurations, which may expand upon the basic structure and operation of the desalination and cooling system 100, offer flexibility and adaptability for different operational requirements and environmental conditions. To provide a more comprehensive understanding of these alternate configurations, each has been discussed separately and in detail with reference to FIGS. 2-24. These figures present diverse embodiments of the integrated desalination and cooling process as per the present disclosure, demonstrating versatility and the wide range of applications it can cater to. The detailed descriptions accompanying these figures further elucidate the operation, benefits, and potential implementations of these alternate configurations, thereby offering a more comprehensive understanding of the present disclosure.

Referring to FIG. 2, illustrated is a schematic diagram of a desalination and cooling system 200 having a single-effect configuration, according to certain embodiments. The desalination and cooling system 200 has many similarities with the desalination and cooling system 100 depicted in FIG. 1, such as integrating an ECC system 202 and an AGMD system 204, combining principles of thermodynamic cycles and heat and mass transfer to produce freshwater and provide a cooling effect. The desalination and cooling system 200 has the ECC system 202 and the AGMD system 204 with similar components to the desalination and cooling system 100. These components interact, generally, in a similar manner across both systems, leveraging heat exchange and mass transfer processes to achieve the desired cooling and desalination outcomes. Further, the integration of the ECC system 202 and the AGMD system 204, the circulation of the feed stream 150, and the flow of the refrigerant 120 within the desalination and cooling system 200 are similar to those in the desalination and cooling system 100. Furthermore, the desalination and cooling system 200, similar to the desalination and cooling system 100, maintains fluid connection of the feed stream 150 in an open loop. Further, the condenser 116 of the ECC system 202 is implemented for further heating the feed stream 150. However, as illustrated in FIG. 2, the desalination and cooling system 200 introduces some distinct features in comparison to the desalination and cooling system 100. These features of the desalination and cooling system 200, which are detailed in the subsequent paragraph(s), cater to specific operational requirements or environmental conditions, thereby extending the versatility and applicability of the desalination and cooling system 200.

A feature of the desalination and cooling system 200 lies in the initial processing of the feed stream 150 within the AGMD system 204. As illustrated in FIG. 2, in the desalination and cooling system 200, the coolant chamber 154 of the AGMD system 204 pre-heats the feed stream 150 before it enters the ECC system 202. The coolant chamber 154 serves as the initial point of contact for the feed stream 150. Within the coolant chamber 154, the feed stream 150 is pre-heated, a process that involves raising its temperature before it enters the ECC system 202. Further, in the desalination and cooling system 200, the feed stream 150 enters the condenser 116, allowing the feed stream 150 to be heated by the super-heated stream of the refrigerant 120 at the condenser 116, and resulting in an increased temperature of the feed stream 150, similar to the desalination and cooling system 100. In the desalination and cooling system 200, pre-heating the feed stream 150 reduces the energy required for subsequent heating in the ECC system 202. In other words, by elevating the initial temperature of the feed stream 150, the energy needed to reach the desired operating temperatures within the ECC system 202 is lowered. The pre-heating process also provides a cooling effect in the coolant chamber 154 which, in turn, enhances the rate of condensation of vapors in the air gap chamber 156 within the AGMD system 204. Thus, pre-heating of the feed stream 150 within the AGMD system 204 improves the overall energy efficiency of the desalination and cooling system 200.

In particular, the generator 110, in the ECC system 202, is responsible for generating the primary flow of the refrigerant 120. The evaporator 112, in the ECC system 202, provides cooling and creates the secondary flow of the refrigerant 120. By absorbing heat, the evaporator 112 increases the temperature of the refrigerant 120, causing it to evaporate and create the secondary flow. This secondary flow then joins the primary flow in the ejector 114. The ejector 114 is designed to combine the primary and secondary flows of the refrigerant 120. The ejector 114 takes in the high-pressure primary flow from the generator 110 and the low-pressure secondary flow from the evaporator 112. When these two flows pass through the ejector 114, they mix and produce a super-heated stream of the refrigerant 120. The condenser 116 receives the super-heated stream of the refrigerant 120 from the ejector 114 and cools it down. This cooling process results in the condensation of the refrigerant, which releases a significant amount of latent heat.

Further, in the AGMD system 204, the feed chamber 152 is configured to receive a hot stream (which is, generally, same as the feed stream 150, with the two terms being interchangeably used). Further, the coolant chamber 154 is configured to receive a cold stream (which again is, generally, same as the feed stream 150, with the two terms being interchangeably used). The hot stream and the cold stream may be any source of water that requires desalination, such as sea water, brackish water, or even waste water. The membrane 158 is disposed between the feed chamber 152 and the air gap chamber 156. The membrane 158 is designed with a plurality of pores which are configured to selectively allow the passage of water vapor. This selective permeability allows only the water vapor originating from the feed stream 150 to pass from the feed chamber 152 through the membrane 158 to the air gap chamber 156, effectively separating the water from the other contaminants present in the feed stream. The air gap chamber 156 is situated between the feed chamber 152 and the coolant chamber 154, providing an intermediate space for the permeation of water vapor from the feed chamber 152 to the air gap chamber 156. The air gap chamber 156, due to its positioning and configuration, allows for the condensation of the water vapor into freshwater 162. This arrangement allows the desalination and cooling system 200 to achieve an efficient separation of water from the other contaminants in the feed stream 150.

Specifically, in the desalination and cooling system 200, the ECC system 202 and the AGMD system 204 are integrated and connected at the condenser 116 in a manner that allows the feed stream 150 to be heated by the super-heated stream of the refrigerant 120 at the condenser 116. This setup results in production of the feed stream 150, which is then directed to the feed chamber 152 of the AGMD system 204. More specifically, in the coolant chamber 154, the feed stream 150 becomes pre-heated, which simultaneously maintains the low temperature of the cold wall 160, thus providing the necessary low temperature to the air gap chamber 156. Herein, the coolant chamber 154 and the air gap chamber 156 of the desalination and cooling system 200 are configured in such a way to allow heat exchange between them. This configuration enables the coolant chamber 154 to pre-heat the feed stream 150, while maintaining the low temperature of the cold wall 160 and, by extension, the air gap chamber 156. Therefore, by using the waste heat from the ECC system 202 to pre-heat the feed stream 150, the desalination and cooling system 200 improves energy utilization and maximizes the overall productivity of the desalination and cooling process. Thereby, the desalination and cooling system 200 allows for efficient desalination and cooling processes by combining the functionalities of the ECC system 202 and the AGMD system 204.

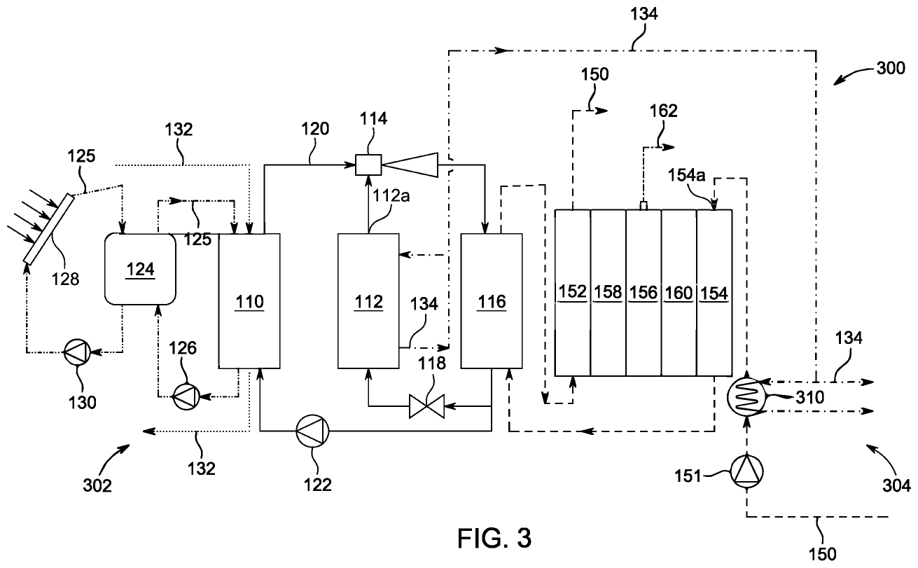

Referring to FIG. 3, illustrated is a schematic diagram of a desalination and cooling system 300 having a single-effect configuration, according to certain embodiments. The desalination and cooling system 300 has many similarities with the desalination and cooling system 200 depicted in FIG. 2, such as integrating an ECC system 302 and an AGMD system 304, combining principles of thermodynamic cycles and heat and mass transfer to produce freshwater and provide a cooling effect. The desalination and cooling system 300 has the ECC system 302 and the AGMD system 304 with similar components to the desalination and cooling system 200. These components interact, generally, in a similar manner across both systems, leveraging heat exchange and mass transfer processes to achieve the desired cooling and desalination outcomes. Further, the integration of the ECC system 302 and the AGMD system 304, the circulation of the feed stream 150, and the flow of the refrigerant 120 within the desalination and cooling system 300 are similar to those in the desalination and cooling system 200. Furthermore, the desalination and cooling system 300, similar to the desalination and cooling system 200, maintains fluid connection of the feed stream 150 in an open loop and employs the coolant chamber 154 of the AGMD system 304 for pre-heating the feed stream 150. Also, the condenser 116 of the ECC system 302 is implemented for further heating the feed stream 150. However, as illustrated in FIG. 3, the desalination and cooling system 300 introduces some distinct features in comparison to the desalination and cooling system 200. These features of the desalination and cooling system 300, which are detailed in the subsequent paragraph(s), cater to specific operational requirements or environmental conditions, thereby extending the versatility and applicability of the desalination and cooling system 300.

A feature of the desalination and cooling system 300 lies in ability to utilize a portion of the cooling effect 134 (as represented by dashed-dotted lines) provided by the evaporator 112 of the ECC system 302 to cool an intake of the feed stream 150 (like, for generation of the feed stream 150). That is, in the desalination and cooling system 300, a part of the cooling effect 134 generated by the evaporator 112 is harnessed to cool the feed stream 150 before being fed to the coolant chamber 154. This cooling effect 134 may be passed using the refrigerant 120 or some other fluid, without any limitations. For this purposes, as illustrated, an outlet 112a of the evaporator 112 is connected to an inlet 154a of the coolant chamber 154 so that the evaporator 112 is configured to provide cooling for the feed stream 150 before the feed stream 150 enters the coolant chamber 154. Further, as illustrated, the desalination and cooling system 300 may include a heat exchanger 310 which allows for efficient heat transfer between the feed stream 150, and the refrigerant 120 (or said other fluid) from the evaporator 112 of the ECC system 302. Within the heat exchanger 310, these two streams come into close proximity but do not mix, creating an efficient setup for heat transfer. This cooling step of the feed stream 150 may enhance the efficiency of the vapor generation process within the AGMD system 304. By reducing the temperature of the feed stream 150 before it enters the coolant chamber 154, the temperature gradient across the membrane 158 (i.e., with respect the feed chamber 152) is maximized. This larger temperature difference may stimulate a more efficient vapor generation process, leading to increased desalination productivity. Herein, the heat exchanger 310 may be of any suitable types which may include, but not limited to, plate heat exchanger, tube in tube heat exchangers, shell and tube heat exchangers, plate and shell heat exchanger, plate fin heat exchanger, double tube heat exchangers, adiabatic wheel heat exchanger, finned tube heat exchanger and other heat exchanger variants.

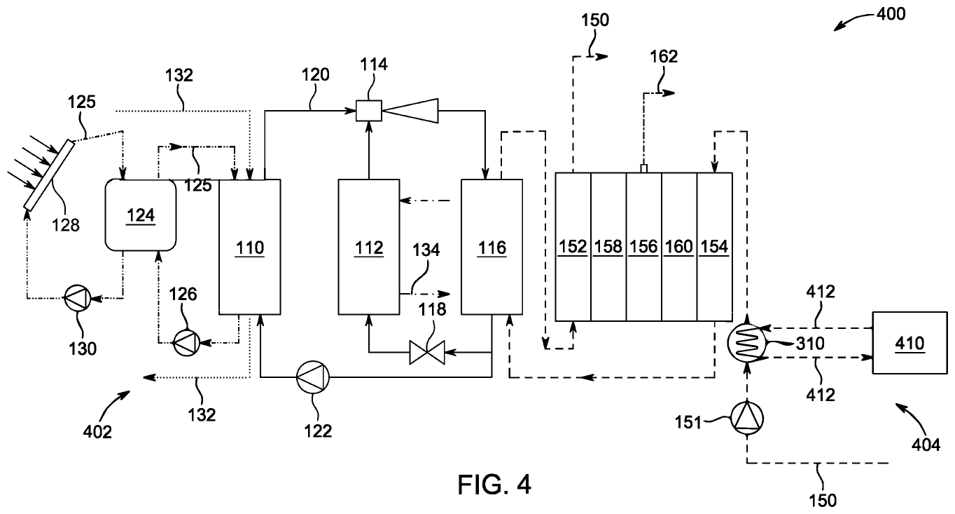

Referring to FIG. 4, illustrated is a schematic diagram of a desalination and cooling system 400 having a single-effect configuration, according to certain embodiments. The desalination and cooling system 400 has many similarities with the desalination and cooling system 200 depicted in FIG. 2, such as integrating an ECC system 402 and an AGMD system 404, combining principles of thermodynamic cycles and heat and mass transfer to produce freshwater and provide a cooling effect. The desalination and cooling system 400 has the ECC system 402 and the AGMD system 404 with similar components to the desalination and cooling system 200. These components interact, generally, in a similar manner across both systems, leveraging heat exchange and mass transfer processes to achieve the desired cooling and desalination outcomes. Further, the integration of the ECC system 402 and the AGMD system 404, the circulation of the feed stream 150, and the flow of the refrigerant 120 within the desalination and cooling system 400 are similar to those in the desalination and cooling system 200. Furthermore, the desalination and cooling system 400, similar to the desalination and cooling system 200, maintains fluid connection of the feed stream 150 in an open loop and employs the coolant chamber 154 of the AGMD system 404 for pre-heating the feed stream 150. Also, the condenser 116 of the ECC system 402 is implemented for further heating the feed stream 150. However, as illustrated in FIG. 4, the desalination and cooling system 400 introduces some distinct features in comparison to the desalination and cooling system 200. These features of the desalination and cooling system 400, which are detailed in the subsequent paragraph(s), cater to specific operational requirements or environmental conditions, thereby extending the versatility and applicability of the desalination and cooling system 400.

A feature of the desalination and cooling system 400 lies in incorporation of an external cooling source in the form of an external chiller 410 (or the like) providing a coolant, which may be water, same as the feed stream 150, in the form of a chilled stream 412. Herein, the chilled stream 412 is used to further cool the feed stream 150, before the feed stream 150 enters the coolant chamber 154, using a heat exchanger (such as the heat exchanger 310). This feature sets the desalination and cooling system 400 apart from the previously discussed desalination and cooling system 300. That is, unlike the desalination and cooling system 300, which utilizes the cooling effect 134 of the evaporator 112, the desalination and cooling system 400 utilizes the external chiller 410 for this cooling process. The external chiller 410 may be any device capable of providing a cooling effect, such as, but not limited to, an ambient cooler, a geothermal cooling system, or the like. The introduction of the external chiller 410 provides additional flexibility in managing the thermal conditions of the feed stream 150. By utilizing the external chiller 410, the desalination and cooling system 400 may effectively control temperature of the feed stream 150 regardless of the operating conditions of the ECC system 402. This allows for more precise control which may enhance the efficiency of the vapor generation process in the AGMD system 404. Furthermore, the use of the external chiller 410 allows the desalination and cooling system 400 to adapt to a wider range of operational conditions and environmental scenarios. Depending on the available resources and specific requirements, different type of the external chiller 410 may be employed, making the desalination and cooling system 400 highly adaptable.

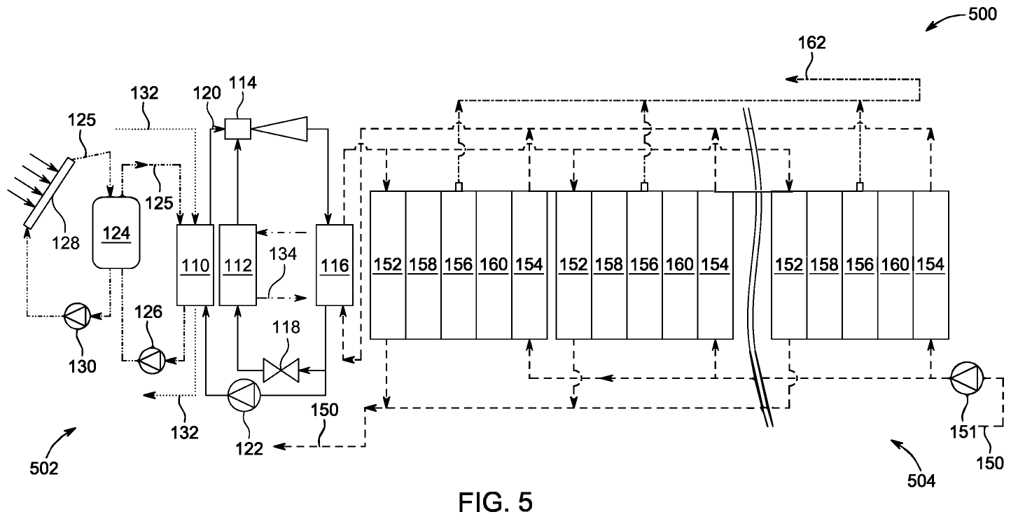

Referring to FIG. 5, illustrated is a schematic diagram of a desalination and cooling system 500 having a multi-effect configuration, according to certain embodiments. The desalination and cooling system 500 has many similarities with the desalination and cooling system 200 depicted in FIG. 2, such as integrating an ECC system 502 and an AGMD system 504, combining principles of thermodynamic cycles and heat and mass transfer to produce freshwater and provide a cooling effect. The desalination and cooling system 500 has the ECC system 502 and the AGMD system 504 with similar components to the desalination and cooling system 200. These components interact, generally, in a similar manner across both systems, leveraging heat exchange and mass transfer processes to achieve the desired cooling and desalination outcomes. Further, the integration of the ECC system 502 and the AGMD system 504, the circulation of the feed stream 150, and the flow of the refrigerant 120 within the desalination and cooling system 500 are similar to those in the desalination and cooling system 200. Furthermore, the desalination and cooling system 500, similar to the desalination and cooling system 200, maintains fluid connection of the feed stream 150 in an open loop and employs the coolant chamber 154 of the AGMD system 504 for pre-heating the feed stream 150. Also, the condenser 116 of the ECC system 502 is implemented for further heating the feed stream 150. However, as illustrated in FIG. 5, the desalination and cooling system 500 introduces some distinct features in comparison to the desalination and cooling system 200. These features of the desalination and cooling system 500, which are detailed in the subsequent paragraph(s), cater to specific operational requirements or environmental conditions, thereby extending the versatility and applicability of the desalination and cooling system 500.

A feature of the desalination and cooling system 500, as illustrated in FIG. 5, is its multi-effect configuration. Specifically, in the desalination and cooling system 500, the AGMD system 504 has multi-effect configuration providing multiple AGMD units arranged in a staged manner, and each one including respective feed chamber 152, respective coolant chamber 154, respective air gap chamber 156, and respective membrane 158. These multiple stages offer the opportunity for progressive and incremental heating, vapor generation, and condensation, thereby enhancing the overall efficiency and productivity of the desalination process. It may be understood that the desalination and cooling system 500 utilizes a single ECC system 502. Herein, the AGMD system 504 may have the multiple AGMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the AGMD system 504. The multi-effect configuration provides the desalination and cooling system 500 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple coolant chambers 154 allows for precise control over the temperature and flow rates at each stage, enhancing both the desalination and cooling efficiencies of the desalination and cooling system 500.

Referring to FIG. 6, illustrated is a schematic diagram of a desalination and cooling system 600 having a single-effect configuration, according to certain embodiments. The desalination and cooling system 600 has many similarities with the desalination and cooling system 200 depicted in FIG. 2, such as integrating an ECC system 602 and an AGMD system 604, combining principles of thermodynamic cycles and heat and mass transfer to produce freshwater and provide a cooling effect. The desalination and cooling system 600 has the ECC system 602 and the AGMD system 604 with similar components to the desalination and cooling system 200. These components interact, generally, in a similar manner across both systems, leveraging heat exchange and mass transfer processes to achieve the desired cooling and desalination outcomes. Further, the integration of the ECC system 602 and the AGMD system 604, the circulation of the feed stream 150, and the flow of the refrigerant 120 within the desalination and cooling system 600 are similar to those in the desalination and cooling system 200. Furthermore, the desalination and cooling system 600, similar to the desalination and cooling system 200, maintains fluid connection of the feed stream 150 in an open loop and employs the coolant chamber 154 of the AGMD system 604 for pre-heating the feed stream 150. Also, the condenser 116 of the ECC system 602 is implemented for further heating the feed stream 150. However, as illustrated in FIG. 6, the desalination and cooling system 600 introduces some distinct features in comparison to the desalination and cooling system 200. These features of the desalination and cooling system 600, which are detailed in the subsequent paragraph(s), cater to specific operational requirements or environmental conditions, thereby extending the versatility and applicability of the desalination and cooling system 600.

A feature of the desalination and cooling system 600, as illustrated in FIG. 6, lies in its integration of a heater 610, positioned at an inlet 110a to the generator 110 and an outlet 116a to the condenser 116 of the ECC system 602, for directly heating the feed stream 150. In particular, the ECC system 602 incorporates the heater 610 that is configured to provide heat for the generator 110 to generate the primary flow of the refrigerant 120. As illustrated, the heater 610 may be powered by various heat sources, such as the waste heat 132. The heater 610 transfers this thermal energy to the refrigerant 120 within the generator 110, elevating temperature of the refrigerant 120. Further, the heater 610 is configured to further heat the feed stream 150 after the condenser 116 and before the feed chamber 152. That is, the heater 610 heats the feed stream 150 directly, providing an additional temperature boost before the feed stream 150 enters the feed chamber 152 of the AGMD system 604. By introducing this direct heating stage, the desalination and cooling system 600 may reach higher temperatures for the feed stream 150, which may lead to more efficient vapor generation and consequently, improved desalination productivity. In some embodiments, the heater 610 and the feed chamber 152 may be in direct contact with each other, allowing for immediate and efficient heat transfer from the heater 610 to the feed stream 150. This setup minimizes heat loss, further improving the energy efficiency of the desalination and cooling system 600. The use of the heater 610 provides the desalination and cooling system 600 with additional flexibility. The heater 610 may be easily controlled to adjust temperature of the feed stream 150 based on specific desalination requirements, ambient conditions, or energy availability. This means that the desalination and cooling system 600 may be adapted to a wide range of scenarios and operational conditions. Herein, the heater 610 may be of any suitable types which may include, but not limited to, plate heat exchanger, tube in tube heat exchangers, shell and tube heat exchangers, plate and shell heat exchanger, plate fin heat exchanger, double tube heat exchangers, adiabatic wheel heat exchanger, finned tube heat exchanger and other heat exchanger variants.

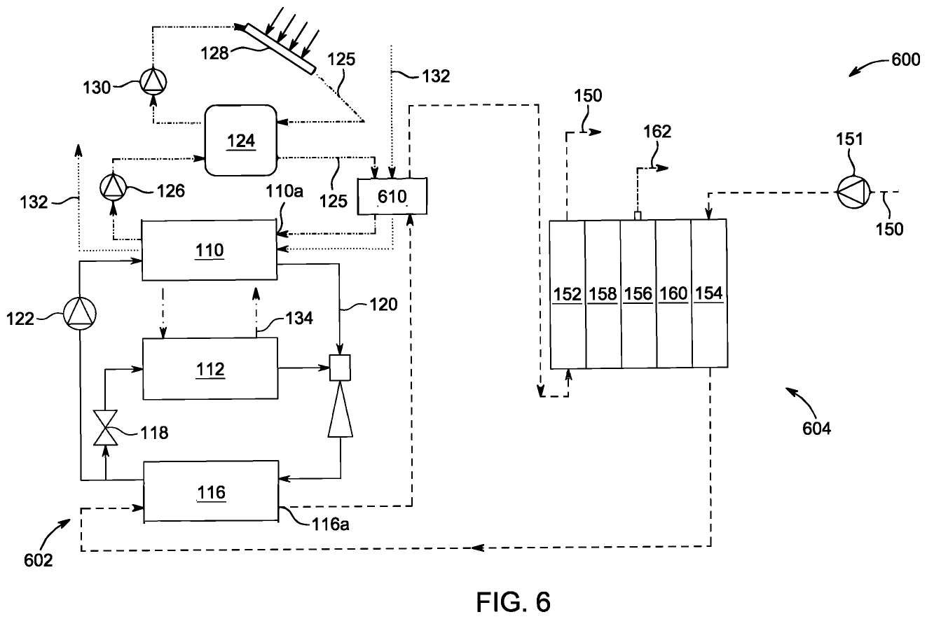

Referring to FIG. 7, illustrated is a schematic diagram of a desalination and cooling system 700 having a single-effect configuration, according to certain embodiments. The desalination and cooling system 700 has many similarities with the desalination and cooling system 600 depicted in FIG. 6, such as integrating an ECC system 702 and an AGMD system 704, combining principles of thermodynamic cycles and heat and mass transfer to produce freshwater and provide a cooling effect. The desalination and cooling system 700 has the ECC system 702 and the AGMD system 704 with similar components to the desalination and cooling system 600. These components interact, generally, in a similar manner across both systems, leveraging heat exchange and mass transfer processes to achieve the desired cooling and desalination outcomes. Further, the integration of the ECC system 702 and the AGMD system 704, the circulation of the feed stream 150, and the flow of the refrigerant 120 within the desalination and cooling system 700 are similar to those in the desalination and cooling system 600. Furthermore, the desalination and cooling system 700, similar to the desalination and cooling system 600, maintains fluid connection of the feed stream 150 in an open loop and employs the coolant chamber 154 of the AGMD system 704 for pre-heating the feed stream 150. Also, the condenser 116 of the ECC system 702 is implemented for further heating the feed stream 150. However, as illustrated in FIG. 7, the desalination and cooling system 700 introduces some distinct features in comparison to the desalination and cooling system 600. These features of the desalination and cooling system 700, which are detailed in the subsequent paragraph(s), cater to specific operational requirements or environmental conditions, thereby extending the versatility and applicability of the desalination and cooling system 700.

A feature of the desalination and cooling system 700, as illustrated in FIG. 7, is its dual functionality of both heating and cooling the feed stream 150, achieved through the integration of the heater 610 at the inlet 110a to the generator 110 of the ECC system 702 and the utilization of the cooling effect provided by the evaporator 112 of the ECC system 702. Similar to the desalination and cooling system 600, the desalination and cooling system 700 incorporates the additional heating stage through the inclusion of the heater 610. The heater 610 directly heats the feed stream 150, elevating its temperature before it enters the feed chamber 152 of the AGMD system 704. The direct heating from the heater 610 may lead to more efficient vapor generation, resulting in improved desalination productivity. Additionally, the desalination and cooling system 700 also takes advantage of the cooling effect 134 produced by the evaporator 112 of the ECC system 702. A portion of the cooling effect 134 is utilized to cool the feed stream 150, via the heat exchanger 310, to be fed to the coolant chamber 154 (similar to the desalination and cooling system 300), which helps manage the thermal load and enhances the overall energy efficiency of the desalination and cooling system 700. The dual functionality of the desalination and cooling system 700, providing additional heating to the feed stream 150 entering the feed chamber 152 while also cooling the feed stream 150 entering the coolant chamber 154, gives it a distinctive operational advantage. The desalination and cooling system 700 not only improves the conditions for vapor generation in the AGMD system 704, but also effectively manages the thermal conditions of the feed stream 150. The ability to both heat and cool the feed stream 150 in the single integrated desalination and cooling system 700 allows for more precise control over the temperatures of the feed streams 150, which may lead to a more efficient and productive desalination process.

Referring to FIG. 8, illustrated is a schematic diagram of a desalination and cooling system 800 having a single-effect configuration, according to certain embodiments. The desalination and cooling system 800 has many similarities with the desalination and cooling system 600 depicted in FIG. 6, such as integrating an ECC system 802 and an AGMD system 804, combining principles of thermodynamic cycles and heat and mass transfer to produce freshwater and provide a cooling effect. The desalination and cooling system 800 has the ECC system 802 and the AGMD system 804 with similar components to the desalination and cooling system 600. These components interact, generally, in a similar manner across both systems, leveraging heat exchange and mass transfer processes to achieve the desired cooling and desalination outcomes. Further, the integration of the ECC system 802 and the AGMD system 804, the circulation of the feed stream 150, and the flow of the refrigerant 120 within the desalination and cooling system 800 are similar to those in the desalination and cooling system 600. Furthermore, the desalination and cooling system 800, similar to the desalination and cooling system 600, maintains fluid connection of the feed stream 150 in an open loop and employs the coolant chamber 154 of the AGMD system 804 for pre-heating the feed stream 150. Also, the condenser 116 of the ECC system 802 is implemented for further heating the feed stream 150. However, as illustrated in FIG. 8, the desalination and cooling system 800 introduces some distinct features in comparison to the desalination and cooling system 600. These features of the desalination and cooling system 800, which are detailed in the subsequent paragraph(s), cater to specific operational requirements or environmental conditions, thereby extending the versatility and applicability of the desalination and cooling system 800.

A feature of the desalination and cooling system 800, as illustrated in FIG. 8, is its dual functionality of both heating and cooling the feed stream 150, where the external chiller 410 is employed to cool the feed stream 150. This feature sets the desalination and cooling system 800 apart from the previously discussed desalination and cooling system 700. That is, unlike the desalination and cooling system 700, which utilizes the cooling effect 134 of the evaporator 112, the desalination and cooling system 800 utilizes the external chiller 410 for this cooling process. The introduction of the external chiller 410 provides additional flexibility in managing the thermal conditions of the feed stream 150. By utilizing the external chiller 410, the desalination and cooling system 800 may effectively control temperature of the feed stream 150 regardless of the operating conditions of the ECC system 802. This allows for more precise control which may enhance the efficiency of the vapor generation process in the AGMD system 804. Furthermore, the use of the external chiller 410 allows the desalination and cooling system 800 to adapt to a wider range of operational conditions and environmental scenarios. Depending on the available resources and specific requirements, different type of the external chiller 410 may be employed, making the desalination and cooling system 800 highly adaptable.

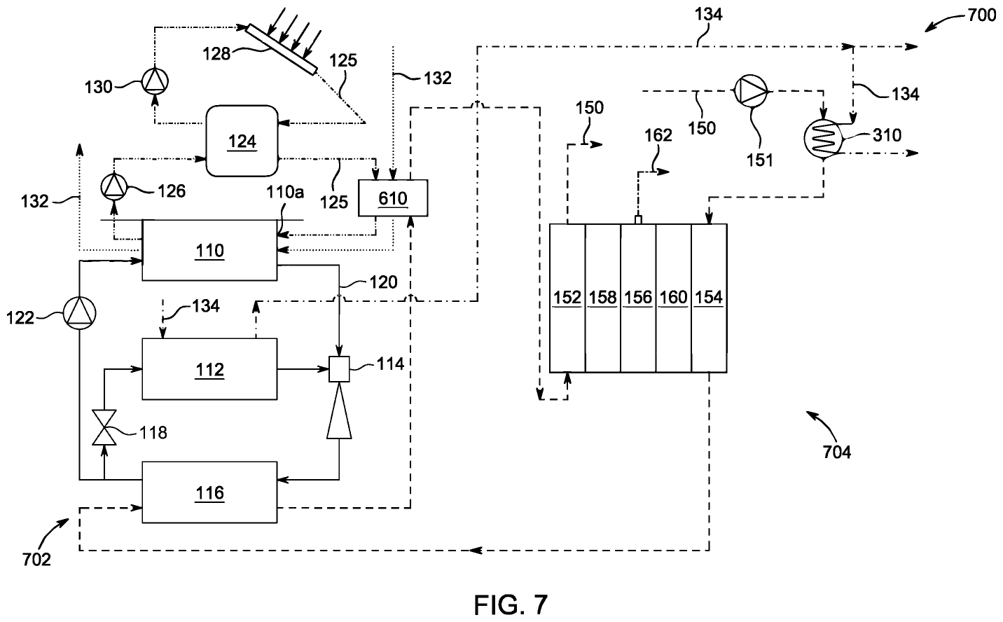

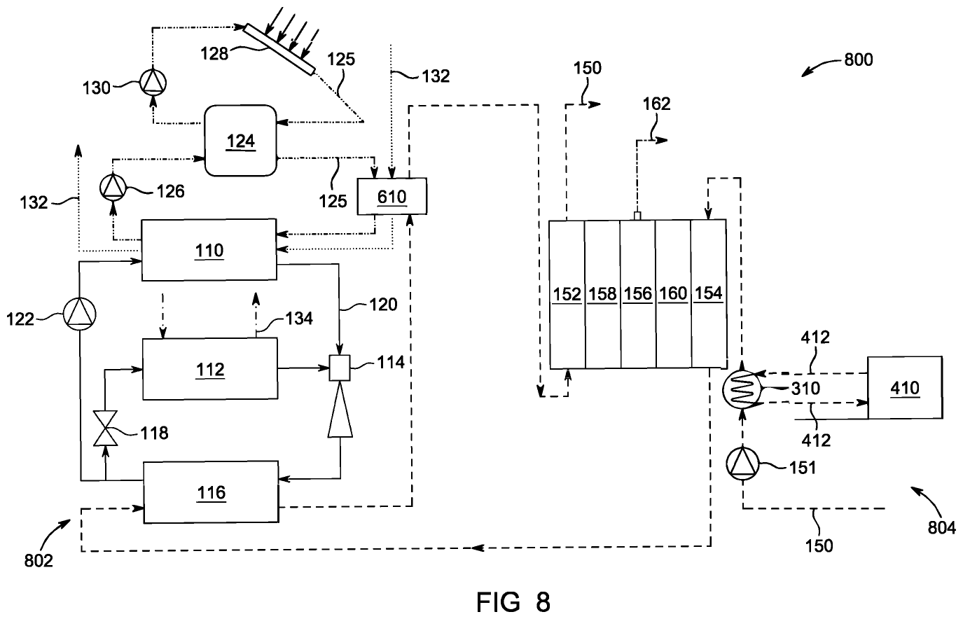

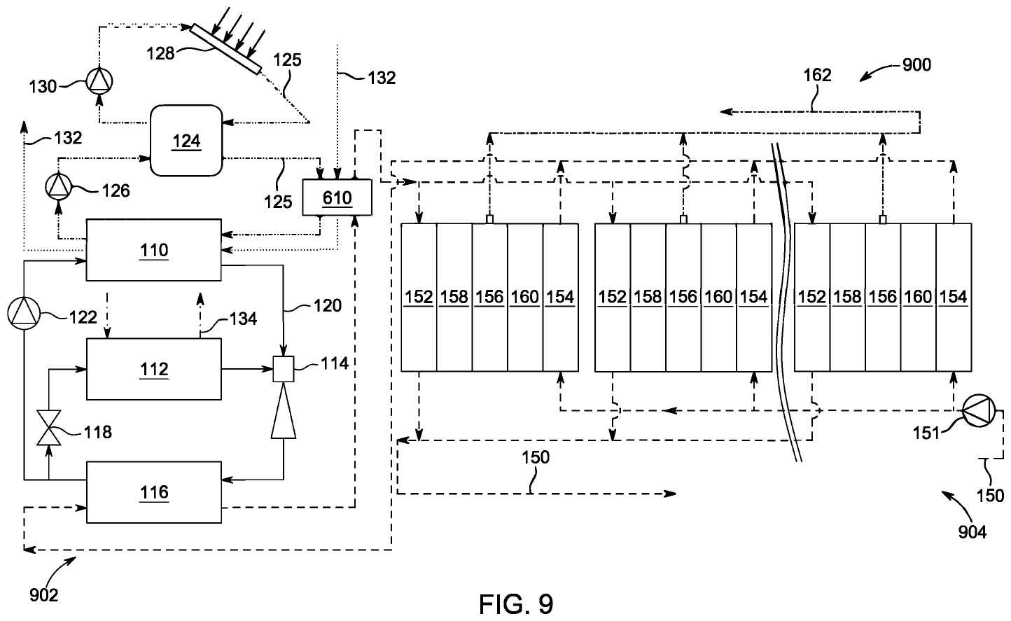

Referring to FIG. 9, illustrated is a schematic diagram of a desalination and cooling system 900 having a multi-effect configuration, according to certain embodiments. The desalination and cooling system 900 has many similarities with the desalination and cooling system 600 depicted in FIG. 6, such as integrating an ECC system 902 and an AGMD system 904, combining principles of thermodynamic cycles and heat and mass transfer to produce freshwater and provide a cooling effect. The desalination and cooling system 900 has the ECC system 902 and the AGMD system 904 with similar components to the desalination and cooling system 600. These components interact, generally, in a similar manner across both systems, leveraging heat exchange and mass transfer processes to achieve the desired cooling and desalination outcomes. Further, the integration of the ECC system 902 and the AGMD system 904, the circulation of the feed stream 150, and the flow of the refrigerant 120 within the desalination and cooling system 900 are similar to those in the desalination and cooling system 600. Furthermore, the desalination and cooling system 900, similar to the desalination and cooling system 600, maintains fluid connection of the feed stream 150 in an open loop and employs the coolant chamber 154 of the AGMD system 904 for pre-heating the feed stream 150. Also, the condenser 116 of the ECC system 902 is implemented for further heating the feed stream 150. However, as illustrated in FIG. 9, the desalination and cooling system 900 introduces some distinct features in comparison to the desalination and cooling system 600. These features of the desalination and cooling system 900, which are detailed in the subsequent paragraph(s), cater to specific operational requirements or environmental conditions, thereby extending the versatility and applicability of the desalination and cooling system 900.

A feature of the desalination and cooling system 900, as illustrated in FIG. 9, is its multi-effect configuration. Specifically, in the desalination and cooling system 900, the AGMD system 904 has multi-effect configuration providing multiple AGMD units arranged in a staged manner, and each one including respective feed chamber 152, respective coolant chamber 154, respective air gap chamber 156, and respective membrane 158. These multiple stages offer the opportunity for progressive and incremental heating, vapor generation, and condensation, thereby enhancing the overall efficiency and productivity of the desalination process. It may be understood that the desalination and cooling system 900 utilizes a single ECC system 902. Herein, the AGMD system 904 may have the multiple AGMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the AGMD system 904. The multi-effect configuration provides the desalination and cooling system 900 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple coolant chambers 154 allows for precise control over the temperature and flow rates at each stage, enhancing both the desalination and cooling efficiencies of the desalination and cooling system 900.

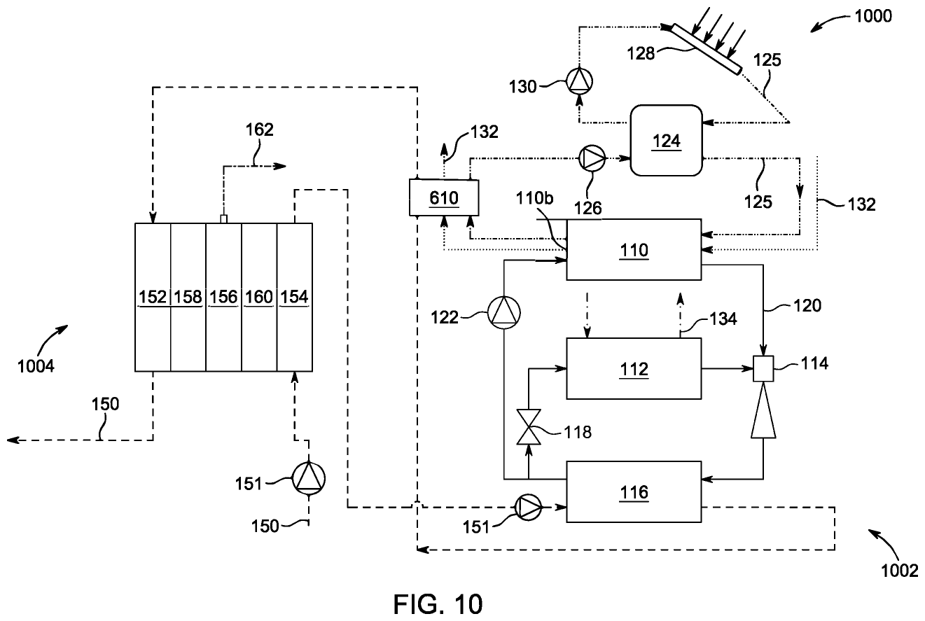

Referring to FIG. 10, illustrated is a schematic diagram of a desalination and cooling system 1000 having a single-effect configuration, according to certain embodiments. The desalination and cooling system 1000 has many similarities with the desalination and cooling system 600 depicted in FIG. 6, such as integrating an ECC system 1002 and an AGMD system 1004, combining principles of thermodynamic cycles and heat and mass transfer to produce freshwater and provide a cooling effect. The desalination and cooling system 1000 has the ECC system 1002 and the AGMD system 1004 with similar components to the desalination and cooling system 600. These components interact, generally, in a similar manner across both systems, leveraging heat exchange and mass transfer processes to achieve the desired cooling and desalination outcomes. Further, the integration of the ECC system 1002 and the AGMD system 1004, the circulation of the feed stream 150, and the flow of the refrigerant 120 within the desalination and cooling system 1000 are similar to those in the desalination and cooling system 600. Furthermore, the desalination and cooling system 1000, similar to the desalination and cooling system 600, maintains fluid connection of the feed stream 150 in an open loop and employs the coolant chamber 154 of the AGMD system 1004 for pre-heating the feed stream 150. Also, the condenser 116 of the ECC system 1002 is implemented for further heating the feed stream 150. However, as illustrated in FIG. 10, the desalination and cooling system 1000 introduces some distinct features in comparison to the desalination and cooling system 600. These features of the desalination and cooling system 1000, which are detailed in the subsequent paragraph(s), cater to specific operational requirements or environmental conditions, thereby extending the versatility and applicability of the desalination and cooling system 1000.

A feature of the desalination and cooling system 1000, as illustrated in FIG. 10, is its integration of the heater 610 at an outlet 110b of the generator 110 of the ECC system 1002, providing additional heating to the feed stream 150. The desalination and cooling system 1000 is distinguished by its placement of the heater 610 at the outlet 110b of the generator 110, as compared to at the inlet 110a of the generator 110 in the desalination and cooling system 600. In the present configuration, the heater 610 may use the heated refrigerant 120 from the generator 110 (which may use the waste heat 132 directly) for providing the heat, and further exhaust the remaining waste heat 132 out. Herein, the heater 610 provides additional heating to the feed stream 150 after it has been processed by the condenser 116 in the ECC system 1002, further elevating its temperature before it enters the feed chamber 152 of the AGMD system 1004. This additional heating may lead to more efficient vapor generation, which in turn may enhance desalination productivity. The integration of the heater 610 at the outlet 110b of the generator 110 provides the desalination and cooling system 1000 with a operational advantage. The heater 610 enables the desalination and cooling system 1000 to control the temperature of the feed stream 150 more precisely, allowing for improvement of the conditions for vapor generation in the AGMD system 1004. This capability may lead to a more efficient and productive desalination process, and may further lead to improvements in the overall energy efficiency of the desalination and cooling system 1000, making it more economical to operate.

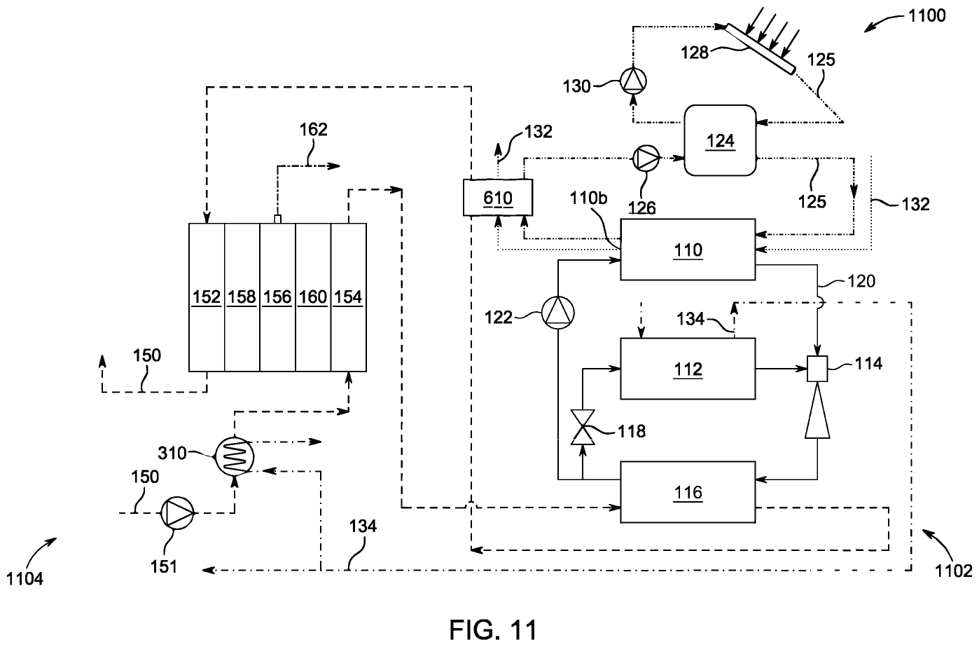

Referring to FIG. 11, illustrated is a schematic diagram of a desalination and cooling system 1100 having a single-effect configuration, according to certain embodiments. The desalination and cooling system 1100 has many similarities with the desalination and cooling system 1000 depicted in FIG. 10, such as integrating an ECC system 1102 and an AGMD system 1104, combining principles of thermodynamic cycles and heat and mass transfer to produce freshwater and provide a cooling effect. The desalination and cooling system 1100 has the ECC system 1102 and the AGMD system 1104 with similar components to the desalination and cooling system 1000. These components interact, generally, in a similar manner across both systems, leveraging heat exchange and mass transfer processes to achieve the desired cooling and desalination outcomes. Further, the integration of the ECC system 1102 and the AGMD system 1104, the circulation of the feed stream 150, and the flow of the refrigerant 120 within the desalination and cooling system 1100 are similar to those in the desalination and cooling system 1000. Furthermore, the desalination and cooling system 1100, similar to the desalination and cooling system 1000, maintains fluid connection of the feed stream 150 in an open loop and employs the coolant chamber 154 of the AGMD system 1104 for pre-heating the feed stream 150. Also, the condenser 116 of the ECC system 1102 is implemented for further heating the feed stream 150. However, as illustrated in FIG. 11, the desalination and cooling system 1100 introduces some distinct features in comparison to the desalination and cooling system 1000. These features of the desalination and cooling system 1100, which are detailed in the subsequent paragraph(s), cater to specific operational requirements or environmental conditions, thereby extending the versatility and applicability of the desalination and cooling system 1100.

A feature of the desalination and cooling system 1100, as illustrated in FIG. 11, is its dual functionality of both heating and cooling the feed stream 150, achieved through the integration of the heater 610 at the outlet 110b to the generator 110 of the ECC system 1102 and the utilization of the cooling effect provided by the evaporator 112 of the ECC system 1102. Similar to the desalination and cooling system 1000, the desalination and cooling system 1100 incorporates the additional heating stage through the inclusion of the heater 610. The heater 610 directly heats the feed stream 150, elevating its temperature before it enters the feed chamber 152 of the AGMD system 1104. The direct heating from the heater 610 may lead to more efficient vapor generation, resulting in improved desalination productivity. Additionally, the desalination and cooling system 1100 also takes advantage of the cooling effect 134 produced by the evaporator 112 of the ECC system 1102. A portion of the cooling effect 134 is utilized to cool the feed stream 150, via the heat exchanger 310, to be fed to the coolant chamber 154 (similar to the desalination and cooling system 300, 700), which helps manage the thermal load and enhances the overall energy efficiency of the desalination and cooling system 1100. The dual functionality of the desalination and cooling system 1100, providing additional heating to the feed stream 150 entering the feed chamber 152 while also cooling the feed stream 150 entering the coolant chamber 154, gives it a distinctive operational advantage. The desalination and cooling system 1100 not only improves the conditions for vapor generation in the AGMD system 1104, but also effectively manages the thermal conditions of the feed stream 150. The ability to both heat and cool the feed stream 150 in the single integrated desalination and cooling system 1100 allows for more precise control over the temperatures of the feed streams 150, which may lead to a more efficient and productive desalination process.

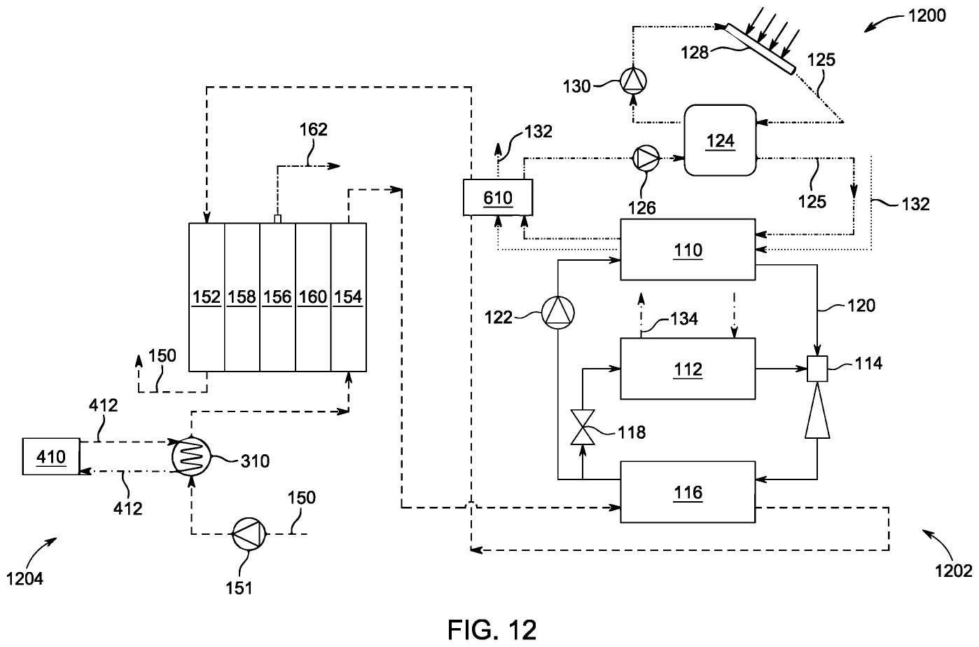

Referring to FIG. 12, illustrated is a schematic diagram of a desalination and cooling system 1200 having a single-effect configuration, according to certain embodiments. The desalination and cooling system 1200 has many similarities with the desalination and cooling system 1000 depicted in FIG. 10, such as integrating an ECC system 1202 and an AGMD system 1204, combining principles of thermodynamic cycles and heat and mass transfer to produce freshwater and provide a cooling effect. The desalination and cooling system 1200 has the ECC system 1202 and the AGMD system 1204 with similar components to the desalination and cooling system 1000. These components interact, generally, in a similar manner across both systems, leveraging heat exchange and mass transfer processes to achieve the desired cooling and desalination outcomes. Further, the integration of the ECC system 1202 and the AGMD system 1204, the circulation of the feed stream 150, and the flow of the refrigerant 120 within the desalination and cooling system 1200 are similar to those in the desalination and cooling system 1000. Furthermore, the desalination and cooling system 1200, similar to the desalination and cooling system 1000, maintains fluid connection of the feed stream 150 in an open loop and employs the coolant chamber 154 of the AGMD system 1204 for pre-heating the feed stream 150. Also, the condenser 116 of the ECC system 1202 is implemented for further heating the feed stream 150. However, as illustrated in FIG. 12, the desalination and cooling system 1200 introduces some distinct features in comparison to the desalination and cooling system 1000. These features of the desalination and cooling system 1200, which are detailed in the subsequent paragraph(s), cater to specific operational requirements or environmental conditions, thereby extending the versatility and applicability of the desalination and cooling system 1200.

A feature of the desalination and cooling system 1200, as illustrated in FIG. 12, is its dual functionality of both heating and cooling the feed stream 150, where the external chiller 410 is employed to cool the feed stream 150. This feature sets the desalination and cooling system 1200 apart from the previously discussed desalination and cooling system 1100. That is, unlike the desalination and cooling system 1100, which utilizes the cooling effect 134 of the evaporator 112, the desalination and cooling system 1200 utilizes the external chiller 410 for this cooling process. The introduction of the external chiller 410 provides additional flexibility in managing the thermal conditions of the feed stream 150. By utilizing the external chiller 410, the desalination and cooling system 1200 may effectively control temperature of the feed stream 150 regardless of the operating conditions of the ECC system 1202. This allows for more precise control which may enhance the efficiency of the vapor generation process in the AGMD system 1204. Furthermore, the use of the external chiller 410 allows the desalination and cooling system 1200 to adapt to a wider range of operational conditions and environmental scenarios. Depending on the available resources and specific requirements, different type of the external chiller 410 may be employed, making the desalination and cooling system 1200 highly adaptable.

Referring to FIG. 13, illustrated is a schematic diagram of a desalination and cooling system 1300 having a multi-effect configuration, according to certain embodiments. The desalination and cooling system 1300 has many similarities with the desalination and cooling system 1000 depicted in FIG. 10, such as integrating an ECC system 1302 and an AGMD system 1304, combining principles of thermodynamic cycles and heat and mass transfer to produce freshwater and provide a cooling effect. The desalination and cooling system 1300 has the ECC system 1302 and the AGMD system 1304 with similar components to the desalination and cooling system 1000. These components interact, generally, in a similar manner across both systems, leveraging heat exchange and mass transfer processes to achieve the desired cooling and desalination outcomes. Further, the integration of the ECC system 1302 and the AGMD system 1304, the circulation of the feed stream 150, and the flow of the refrigerant 120 within the desalination and cooling system 1300 are similar to those in the desalination and cooling system 1000. Furthermore, the desalination and cooling system 1300, similar to the desalination and cooling system 1000, maintains fluid connection of the feed stream 150 in an open loop and employs the coolant chamber 154 of the AGMD system 1304 for pre-heating the feed stream 150. Also, the condenser 116 of the ECC system 1302 is implemented for further heating the feed stream 150. However, as illustrated in FIG. 13, the desalination and cooling system 1300 introduces some distinct features in comparison to the desalination and cooling system 1000. These features of the desalination and cooling system 1300, which are detailed in the subsequent paragraph(s), cater to specific operational requirements or environmental conditions, thereby extending the versatility and applicability of the desalination and cooling system 1300.

A feature of the desalination and cooling system 1300, as illustrated in FIG. 13, is its multi-effect configuration. Specifically, in the desalination and cooling system 1300, the AGMD system 1304 has multi-effect configuration providing multiple AGMD units arranged in a staged manner, and each one including respective feed chamber 152, respective coolant chamber 154, respective air gap chamber 156, and respective membrane 158. These multiple stages offer the opportunity for progressive and incremental heating, vapor generation, and condensation, thereby enhancing the overall efficiency and productivity of the desalination process. It may be understood that the desalination and cooling system 1300 utilizes a single ECC system 1302. Herein, the AGMD system 1304 may have the multiple AGMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the AGMD system 1304. The multi-effect configuration provides the desalination and cooling system 1300 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple coolant chambers 154 allows for precise control over the temperature and flow rates at each stage, enhancing both the desalination and cooling efficiencies of the desalination and cooling system 1300.

Referring to FIG. 14, illustrated is a schematic diagram of a desalination and cooling system 1400 having a single-effect configuration, according to certain embodiments. The desalination and cooling system 1400 has many similarities with the desalination and cooling system 600 depicted in FIG. 6, such as integrating an ECC system 1402 and an AGMD system 1404, combining principles of thermodynamic cycles and heat and mass transfer to produce freshwater and provide a cooling effect. The desalination and cooling system 1400 has the ECC system 1402 and the AGMD system 1404 with similar components to the desalination and cooling system 600. These components interact, generally, in a similar manner across both systems, leveraging heat exchange and mass transfer processes to achieve the desired cooling and desalination outcomes. Further, the integration of the ECC system 1402 and the AGMD system 1404, the circulation of the feed stream 150, and the flow of the refrigerant 120 within the desalination and cooling system 1400 are similar to those in the desalination and cooling system 600. Furthermore, the desalination and cooling system 1400, similar to the desalination and cooling system 600, maintains fluid connection of the feed stream 150 in an open loop and employs the coolant chamber 154 of the AGMD system 1404 for pre-heating the feed stream 150. Also, the condenser 116 of the ECC system 1402 is implemented for further heating the feed stream 150. However, as illustrated in FIG. 14, the desalination and cooling system 1400 introduces some distinct features in comparison to the desalination and cooling system 600. These features of the desalination and cooling system 1400, which are detailed in the subsequent paragraph(s), cater to specific operational requirements or environmental conditions, thereby extending the versatility and applicability of the desalination and cooling system 1400.

A feature of the desalination and cooling system 1400, as illustrated in FIG. 14, is its integration of the heater 610 at an outlet 114a of the ejector 114 of the ECC system 1402, providing additional heating to the feed stream 150. In the present configuration, the heater 610 may use the super-heated stream of the refrigerant 120 exiting the ejector 114 for providing the heat. Herein, the heater 610 provides additional heating to the feed stream 150 after it has been processed by the condenser 116 in the ECC system 1402, further elevating its temperature before it enters the feed chamber 152 of the AGMD system 1404. This additional heating may lead to more efficient vapor generation, which in turn may enhance desalination productivity. In an alternate configuration, the heater 610 may be configured to further heat the super-heated stream of the refrigerant 120 before the super-heated stream of the refrigerant 120 enters the condenser 116. The integration of the heater 610 at the outlet 114a of the ejector 114 provides the desalination and cooling system 1400 with a operational advantage. The heater 610 enables the desalination and cooling system 1400 to significantly elevate the temperature of the feed stream 150, allowing for increased vapor generation in the AGMD system 1404. This capability may lead to a more efficient and productive desalination process, and may further lead to improvements in the overall energy efficiency of the desalination and cooling system 1400, making it more economical to operate.

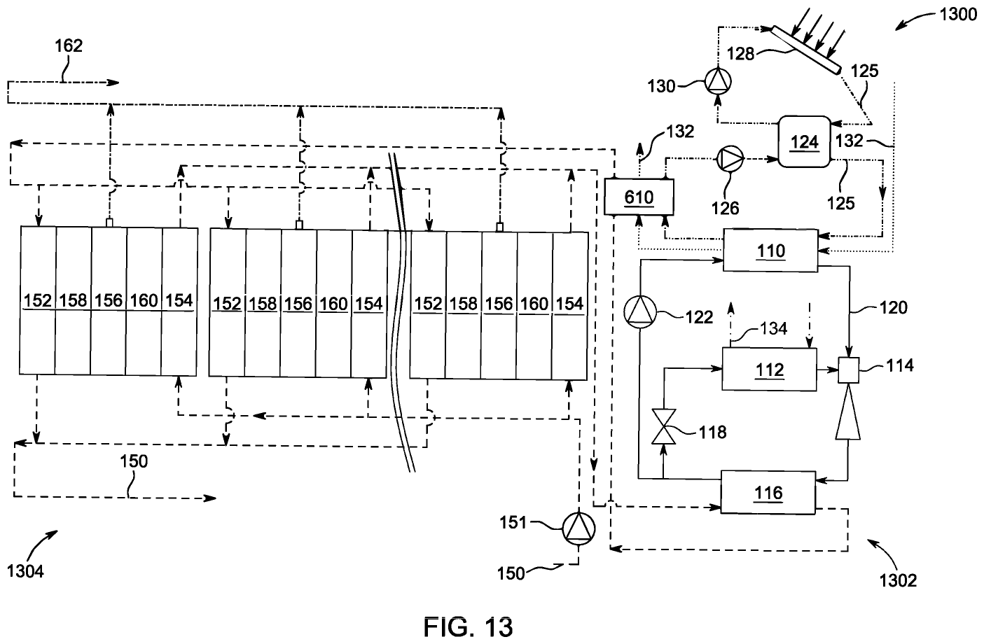

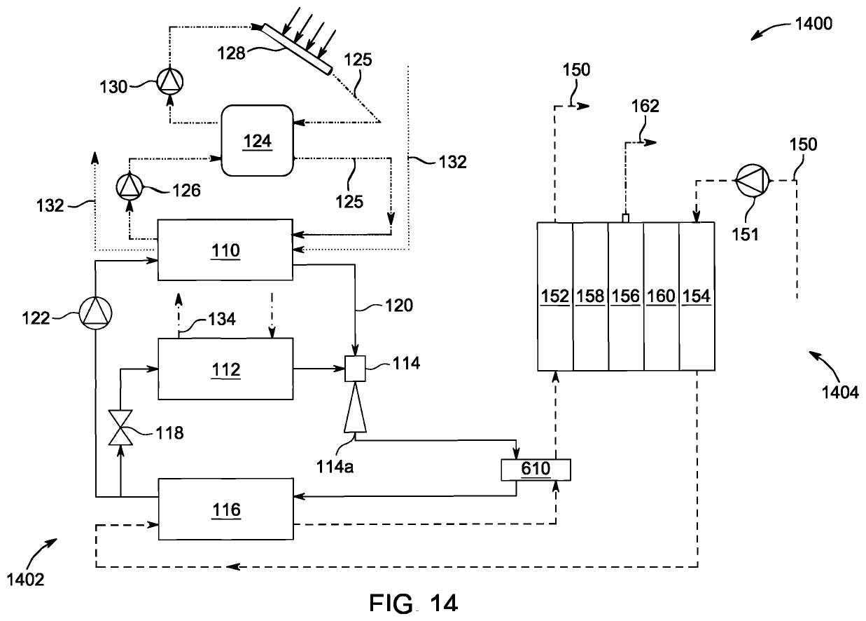

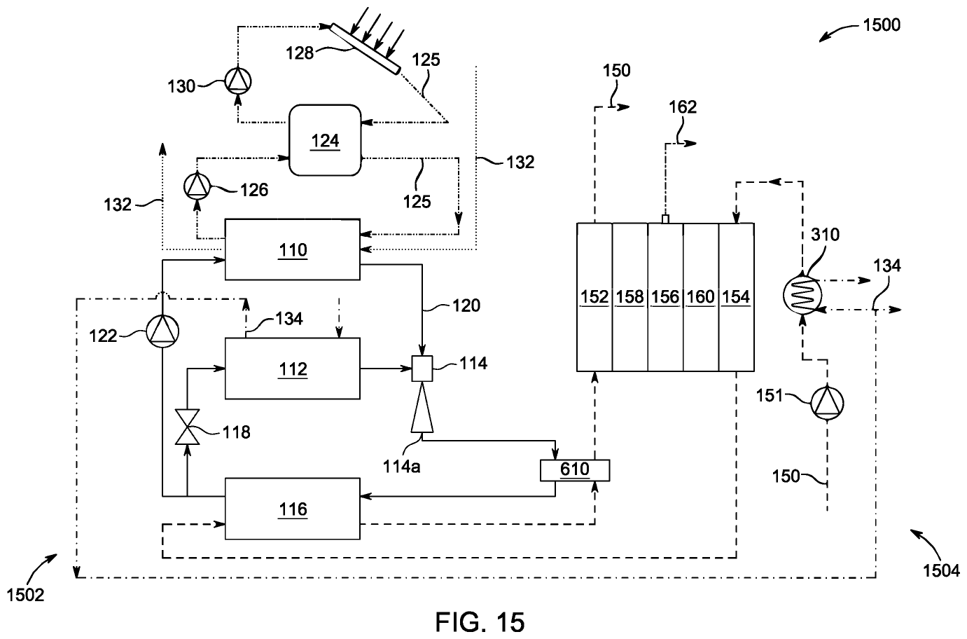

Referring to FIG. 15, illustrated is a schematic diagram of a desalination and cooling system 1500 having a single-effect configuration, according to certain embodiments. The desalination and cooling system 1500 has many similarities with the desalination and cooling system 1400 depicted in FIG. 14, such as integrating an ECC system 1502 and an AGMD system 1504, combining principles of thermodynamic cycles and heat and mass transfer to produce freshwater and provide a cooling effect. The desalination and cooling system 1500 has the ECC system 1502 and the AGMD system 1504 with similar components to the desalination and cooling system 1400. These components interact, generally, in a similar manner across both systems, leveraging heat exchange and mass transfer processes to achieve the desired cooling and desalination outcomes. Further, the integration of the ECC system 1502 and the AGMD system 1504, the circulation of the feed stream 150, and the flow of the refrigerant 120 within the desalination and cooling system 1500 are similar to those in the desalination and cooling system 1400. Furthermore, the desalination and cooling system 1500, similar to the desalination and cooling system 1400, maintains fluid connection of the feed stream 150 in an open loop and employs the coolant chamber 154 of the AGMD system 1504 for pre-heating the feed stream 150. Also, the condenser 116 of the ECC system 1502 is implemented for further heating the feed stream 150. However, as illustrated in FIG. 15, the desalination and cooling system 1500 introduces some distinct features in comparison to the desalination and cooling system 1400. These features of the desalination and cooling system 1500, which are detailed in the subsequent paragraph(s), cater to specific operational requirements or environmental conditions, thereby extending the versatility and applicability of the desalination and cooling system 1500.

A feature of the desalination and cooling system 1500, as illustrated in FIG. 15, is its dual functionality of both heating and cooling the feed stream 150, achieved through the integration of the heater 610 at the outlet 114a to the ejector 114 of the ECC system 1502 and the utilization of the cooling effect provided by the evaporator 112 of the ECC system 1502. Similar to the desalination and cooling system 1400, the desalination and cooling system 1500 incorporates the additional heating stage through the inclusion of the heater 610. The heater 610 directly heats the feed stream 150, elevating its temperature before it enters the feed chamber 152 of the AGMD system 1504. The direct heating from the heater 610 may lead to more efficient vapor generation, resulting in improved desalination productivity. Additionally, the desalination and cooling system 1500 also takes advantage of the cooling effect 134 produced by the evaporator 112 of the ECC system 1502. A portion of the cooling effect 134 is utilized to cool the feed stream 150, via the heat exchanger 310, to be fed to the coolant chamber 154 (similar to the desalination and cooling system 300, 700, 1100), which helps manage the thermal load and enhances the overall energy efficiency of the desalination and cooling system 1500. The dual functionality of the desalination and cooling system 1500, providing additional heating to the feed stream 150 entering the feed chamber 152 while also cooling the feed stream 150 entering the coolant chamber 154, gives it a distinctive operational advantage. The desalination and cooling system 1500 not only improves the conditions for vapor generation in the AGMD system 1504, but also effectively manages the thermal conditions of the feed stream 150. The ability to both heat and cool the feed stream 150 in the single integrated desalination and cooling system 1500 allows for more precise control over the temperatures of the feed streams 150, which may lead to a more efficient and productive desalination process.

Referring to FIG. 16, illustrated is a schematic diagram of a desalination and cooling system 1600 having a single-effect configuration, according to certain embodiments. The desalination and cooling system 1600 has many similarities with the desalination and cooling system 1400 depicted in FIG. 14, such as integrating an ECC system 1602 and an AGMD system 1604, combining principles of thermodynamic cycles and heat and mass transfer to produce freshwater and provide a cooling effect. The desalination and cooling system 1600 has the ECC system 1602 and the AGMD system 1604 with similar components to the desalination and cooling system 1400. These components interact, generally, in a similar manner across both systems, leveraging heat exchange and mass transfer processes to achieve the desired cooling and desalination outcomes. Further, the integration of the ECC system 1602 and the AGMD system 1604, the circulation of the feed stream 150, and the flow of the refrigerant 120 within the desalination and cooling system 1600 are similar to those in the desalination and cooling system 1400. Furthermore, the desalination and cooling system 1600, similar to the desalination and cooling system 1400, maintains fluid connection of the feed stream 150 in an open loop and employs the coolant chamber 154 of the AGMD system 1604 for pre-heating the feed stream 150. Also, the condenser 116 of the ECC system 1602 is implemented for further heating the feed stream 150. However, as illustrated in FIG. 16, the desalination and cooling system 1600 introduces some distinct features in comparison to the desalination and cooling system 1400. These features of the desalination and cooling system 1600, which are detailed in the subsequent paragraph(s), cater to specific operational requirements or environmental conditions, thereby extending the versatility and applicability of the desalination and cooling system 1600.

A feature of the desalination and cooling system 1600, as illustrated in FIG. 16, is its dual functionality of both heating and cooling the feed stream 150, where the external chiller 410 is employed to cool the feed stream 150. This feature sets the desalination and cooling system 1600 apart from the previously discussed desalination and cooling system 1500. That is, unlike the desalination and cooling system 1500, which utilizes the cooling effect 134 of the evaporator 112, the desalination and cooling system 1600 utilizes the external chiller 410 for this cooling process. The introduction of the external chiller 410 provides additional flexibility in managing the thermal conditions of the feed stream 150. By utilizing the external chiller 410, the desalination and cooling system 1600 may effectively control temperature of the feed stream 150 regardless of the operating conditions of the ECC system 1602. This allows for more precise control which may enhance the efficiency of the vapor generation process in the AGMD system 1604. Furthermore, the use of the external chiller 410 allows the desalination and cooling system 1600 to adapt to a wider range of operational conditions and environmental scenarios. Depending on the available resources and specific requirements, different type of the external chiller 410 may be employed, making the desalination and cooling system 1600 highly adaptable.

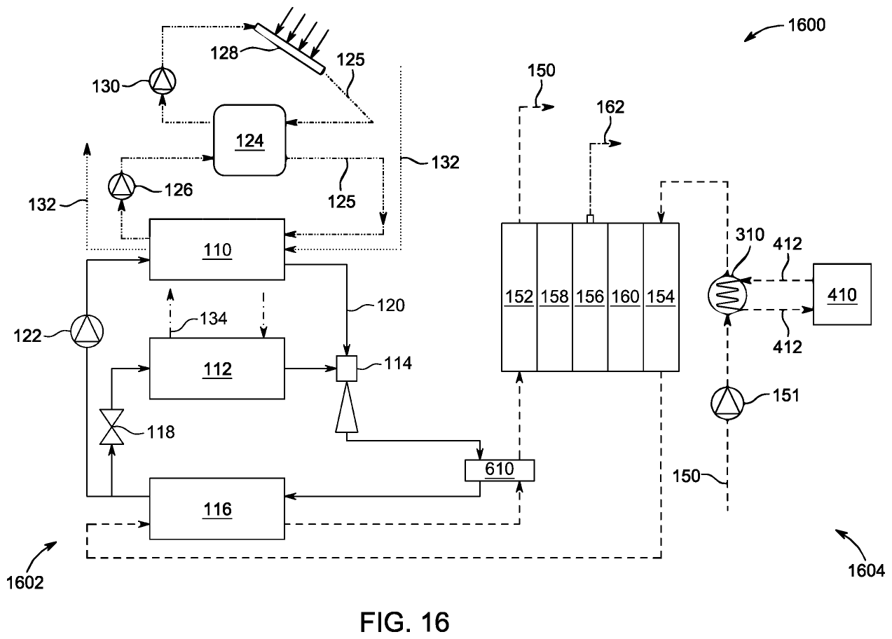

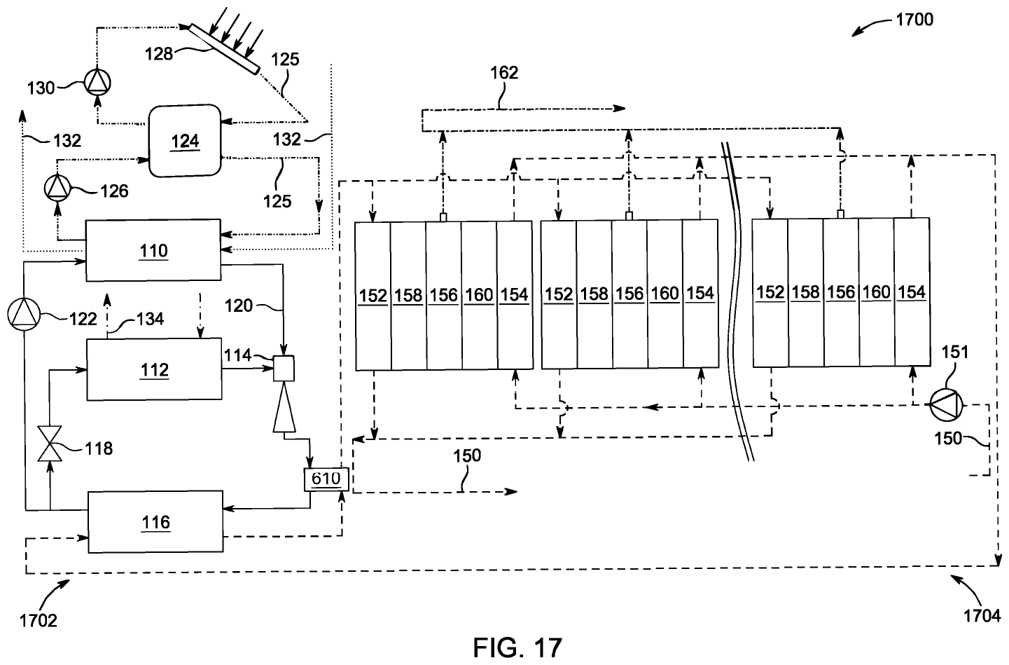

Referring to FIG. 17, illustrated is a schematic diagram of a desalination and cooling system 1700 having a multi-effect configuration, according to certain embodiments. The desalination and cooling system 1700 has many similarities with the desalination and cooling system 1400 depicted in FIG. 14, such as integrating an ECC system 1702 and an AGMD system 1704, combining principles of thermodynamic cycles and heat and mass transfer to produce freshwater and provide a cooling effect. The desalination and cooling system 1700 has the ECC system 1702 and the AGMD system 1704 with similar components to the desalination and cooling system 1400. These components interact, generally, in a similar manner across both systems, leveraging heat exchange and mass transfer processes to achieve the desired cooling and desalination outcomes. Further, the integration of the ECC system 1702 and the AGMD system 1704, the circulation of the feed stream 150, and the flow of the refrigerant 120 within the desalination and cooling system 1700 are similar to those in the desalination and cooling system 1400. Furthermore, the desalination and cooling system 1700, similar to the desalination and cooling system 1400, maintains fluid connection of the feed stream 150 in an open loop and employs the coolant chamber 154 of the AGMD system 1704 for pre-heating the feed stream 150. Also, the condenser 116 of the ECC system 1702 is implemented for further heating the feed stream 150. However, as illustrated in FIG. 17, the desalination and cooling system 1700 introduces some distinct features in comparison to the desalination and cooling system 1400. These features of the desalination and cooling system 1700, which are detailed in the subsequent paragraph(s), cater to specific operational requirements or environmental conditions, thereby extending the versatility and applicability of the desalination and cooling system 1700.

A feature of the desalination and cooling system 1700, as illustrated in FIG. 17, is its multi-effect configuration. Specifically, in the desalination and cooling system 1700, the AGMD system 1704 has multi-effect configuration providing multiple AGMD units arranged in a staged manner, and each one including respective feed chamber 152, respective coolant chamber 154, respective air gap chamber 156, and respective membrane 158. These multiple stages offer the opportunity for progressive and incremental heating, vapor generation, and condensation, thereby enhancing the overall efficiency and productivity of the desalination process. It may be understood that the desalination and cooling system 1700 utilizes a single ECC system 1702. Herein, the AGMD system 1704 may have the multiple AGMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the AGMD system 1704. The multi-effect configuration provides the desalination and cooling system 1700 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple coolant chambers 154 allows for precise control over the temperature and flow rates at each stage, enhancing both the desalination and cooling efficiencies of the desalination and cooling system 1700.

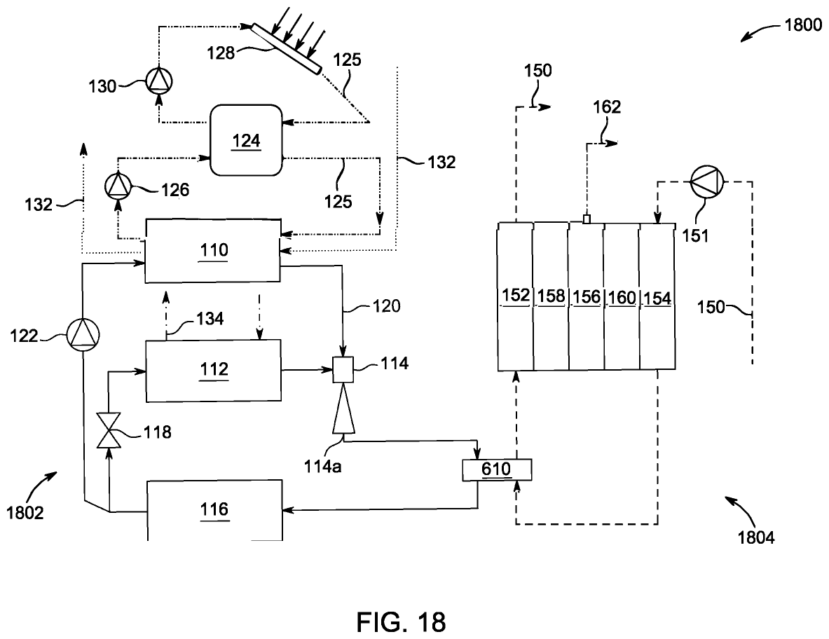

Referring to FIG. 18, illustrated is a schematic diagram of a desalination and cooling system 1800 having a single-effect configuration, according to certain embodiments. The desalination and cooling system 1800 has many similarities with the desalination and cooling system 1400 depicted in FIG. 14, such as integrating an ECC system 1802 and an AGMD system 1804, combining principles of thermodynamic cycles and heat and mass transfer to produce freshwater and provide a cooling effect. The desalination and cooling system 1800 has the ECC system 1802 and the AGMD system 1804 with similar components to the desalination and cooling system 1400. These components interact, generally, in a similar manner across both systems, leveraging heat exchange and mass transfer processes to achieve the desired cooling and desalination outcomes. Further, the integration of the ECC system 1802 and the AGMD system 1804, the circulation of the feed stream 150, and the flow of the refrigerant 120 within the desalination and cooling system 1800 are similar to those in the desalination and cooling system 1400. Furthermore, the desalination and cooling system 1800, similar to the desalination and cooling system 1400, maintains fluid connection of the feed stream 150 in an open loop and employs the coolant chamber 154 of the AGMD system 1804 for pre-heating the feed stream 150. Also, the desalination and cooling system 1800 has the heater 610 located at the outlet 114a of the ejector 114 of the ECC system 1802, providing additional heating to the feed stream 150. However, as illustrated in FIG. 18, the desalination and cooling system 1800 introduces some distinct features in comparison to the desalination and cooling system 1400. These features of the desalination and cooling system 1800, which are detailed in the subsequent paragraph(s), cater to specific operational requirements or environmental conditions, thereby extending the versatility and applicability of the desalination and cooling system 1800.

A feature of the desalination and cooling system 1800, as illustrated in FIG. 18, is that the condenser 116 of the ECC system 1802 is not used (at least directly) for heating the feed stream 150, but the heater 610 is solely and directly used for such purpose. The heater 610 directly heats the feed stream 150, elevating its temperature before it enters the feed chamber 152 of the AGMD system 1804. The direct heating from the heater 610 may lead to more efficient vapor generation, resulting in improved desalination productivity.

Referring to FIG. 19, illustrated is a schematic diagram of a desalination and cooling system 1900 having a single-effect configuration, according to certain embodiments. The desalination and cooling system 1900 has many similarities with the desalination and cooling system 1800 depicted in FIG. 18, such as integrating an ECC system 1902 and an AGMD system 1904, combining principles of thermodynamic cycles and heat and mass transfer to produce freshwater and provide a cooling effect. The desalination and cooling system 1900 has the ECC system 1902 and the AGMD system 1904 with similar components to the desalination and cooling system 1800. These components interact, generally, in a similar manner across both systems, leveraging heat exchange and mass transfer processes to achieve the desired cooling and desalination outcomes. Further, the integration of the ECC system 1902 and the AGMD system 1904, the circulation of the feed stream 150, and the flow of the refrigerant 120 within the desalination and cooling system 1900 are similar to those in the desalination and cooling system 1800. Furthermore, the desalination and cooling system 1900, similar to the desalination and cooling system 1800, maintains fluid connection of the feed stream 150 in an open loop and employs the coolant chamber 154 of the AGMD system 1904 for pre-heating the feed stream 150. Also, the desalination and cooling system 1900 has the heater 610 located at the outlet 114a of the ejector 114 of the ECC system 1902, providing additional heating to the feed stream 150. Further, herein as well, the desalination and cooling system 1900 does not use the condenser 116 of the ECC system 1802 (at least directly) for heating the feed stream 150, but the heater 610 is solely and directly used for such purpose. However, as illustrated in FIG. 19, the desalination and cooling system 1900 introduces some distinct features in comparison to the desalination and cooling system 1800. These features of the desalination and cooling system 1900, which are detailed in the subsequent paragraph(s), cater to specific operational requirements or environmental conditions, thereby extending the versatility and applicability of the desalination and cooling system 1900.

A feature of the desalination and cooling system 1900, as illustrated in FIG. 19, is its dual functionality of both heating and cooling the feed stream 150, achieved through the integration of the heater 610 at the outlet 114a to the ejector 114 of the ECC system 1502 and the utilization of the cooling effect provided by the evaporator 112 of the ECC system 1502. Similar to the desalination and cooling system 1800, the desalination and cooling system 1900 incorporates the heating stage through the inclusion of the heater 610. The heater 610 directly heats the feed stream 150, elevating its temperature before it enters the feed chamber 152 of the AGMD system 1504. The direct heating from the heater 610 may lead to more efficient vapor generation, resulting in improved desalination productivity. Additionally, the desalination and cooling system 1900 also takes advantage of the cooling effect 134 produced by the evaporator 112 of the ECC system 1502. A portion of the cooling effect 134 is utilized to cool the feed stream 150, via the heat exchanger 310, to be fed to the coolant chamber 154 (similar to the desalination and cooling system 300, 700, 1100), which helps manage the thermal load and enhances the overall energy efficiency of the desalination and cooling system 1900. The dual functionality of the desalination and cooling system 1900, providing additional heating to the feed stream 150 entering the feed chamber 152 while also cooling the feed stream 150 entering the coolant chamber 154, gives it a distinctive operational advantage. The desalination and cooling system 1900 not only improves the conditions for vapor generation in the AGMD system 1504, but also effectively manages the thermal conditions of the feed stream 150. The ability to both heat and cool the feed stream 150 in the single integrated desalination and cooling system 1900 allows for more precise control over the temperatures of the feed streams 150, which may lead to a more efficient and productive desalination process.

Referring to FIG. 20, illustrated is a schematic diagram of a desalination and cooling system 2000 having a single-effect configuration, according to certain embodiments. The desalination and cooling system 2000 has many similarities with the desalination and cooling system 1800 depicted in FIG. 18, such as integrating an ECC system 2002 and an AGMD system 2004, combining principles of thermodynamic cycles and heat and mass transfer to produce freshwater and provide a cooling effect. The desalination and cooling system 2000 has the ECC system 2002 and the AGMD system 2004 with similar components to the desalination and cooling system 1800. These components interact, generally, in a similar manner across both systems, leveraging heat exchange and mass transfer processes to achieve the desired cooling and desalination outcomes. Further, the integration of the ECC system 2002 and the AGMD system 2004, the circulation of the feed stream 150, and the flow of the refrigerant 120 within the desalination and cooling system 2000 are similar to those in the desalination and cooling system 1800. Furthermore, the desalination and cooling system 2000, similar to the desalination and cooling system 1800, maintains fluid connection of the feed stream 150 in an open loop and employs the coolant chamber 154 of the AGMD system 2004 for pre-heating the feed stream 150. Also, the desalination and cooling system 2000 has the heater 610 located at the outlet 114a of the ejector 114 of the ECC system 2002, providing additional heating to the feed stream 150. Further, herein as well, the desalination and cooling system 2000 does not use the condenser 116 of the ECC system 1802 (at least directly) for heating the feed stream 150, but the heater 610 is solely and directly used for such purpose. However, as illustrated in FIG. 20, the desalination and cooling system 2000 introduces some distinct features in comparison to the desalination and cooling system 1800. These features of the desalination and cooling system 2000, which are detailed in the subsequent paragraph(s), cater to specific operational requirements or environmental conditions, thereby extending the versatility and applicability of the desalination and cooling system 2000.

A feature of the desalination and cooling system 2000, as illustrated in FIG. 20, is its dual functionality of both heating and cooling the feed stream 150, where the external chiller 410 is employed to cool the feed stream 150. This feature sets the desalination and cooling system 2000 apart from the previously discussed desalination and cooling system 1900. That is, unlike the desalination and cooling system 1900, which utilizes the cooling effect 134 of the evaporator 112, the desalination and cooling system 2000 utilizes the external chiller 410 for this cooling process. The introduction of the external chiller 410 provides additional flexibility in managing the thermal conditions of the feed stream 150. By utilizing the external chiller 410, the desalination and cooling system 2000 may effectively control temperature of the feed stream 150 regardless of the operating conditions of the ECC system 1602. This allows for more precise control which may enhance the efficiency of the vapor generation process in the AGMD system 1604. Furthermore, the use of the external chiller 410 allows the desalination and cooling system 2000 to adapt to a wider range of operational conditions and environmental scenarios. Depending on the available resources and specific requirements, different type of the external chiller 410 may be employed, making the desalination and cooling system 2000 highly adaptable.

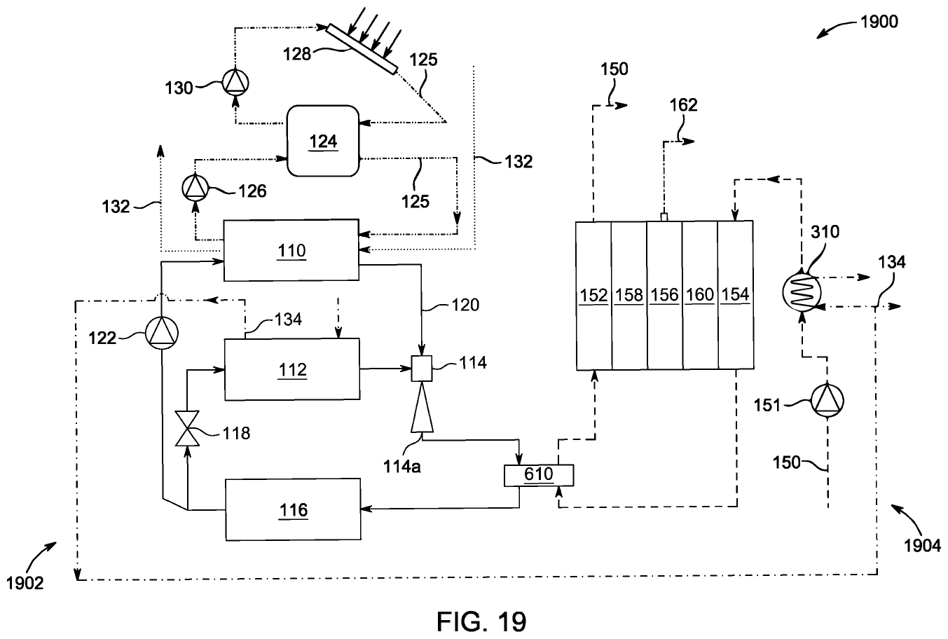

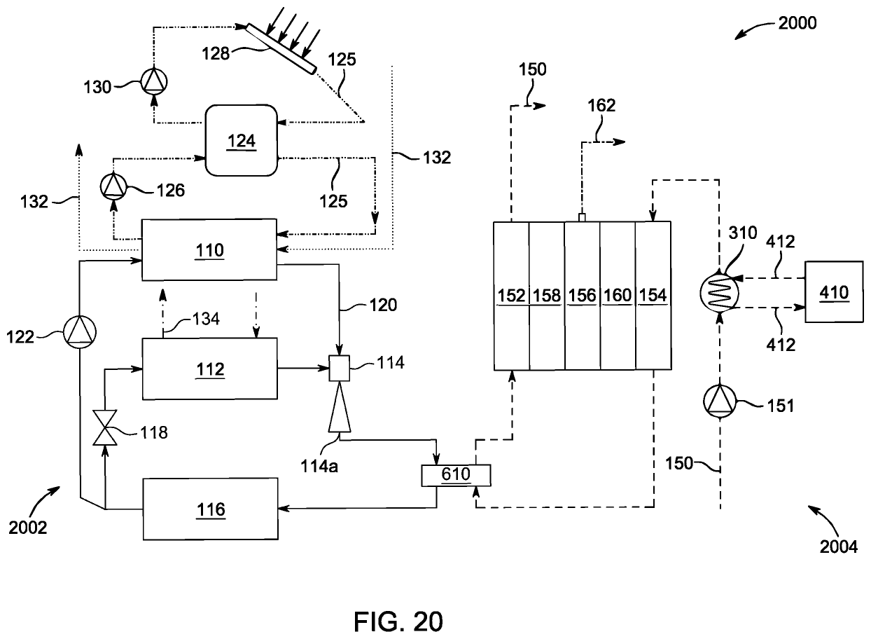

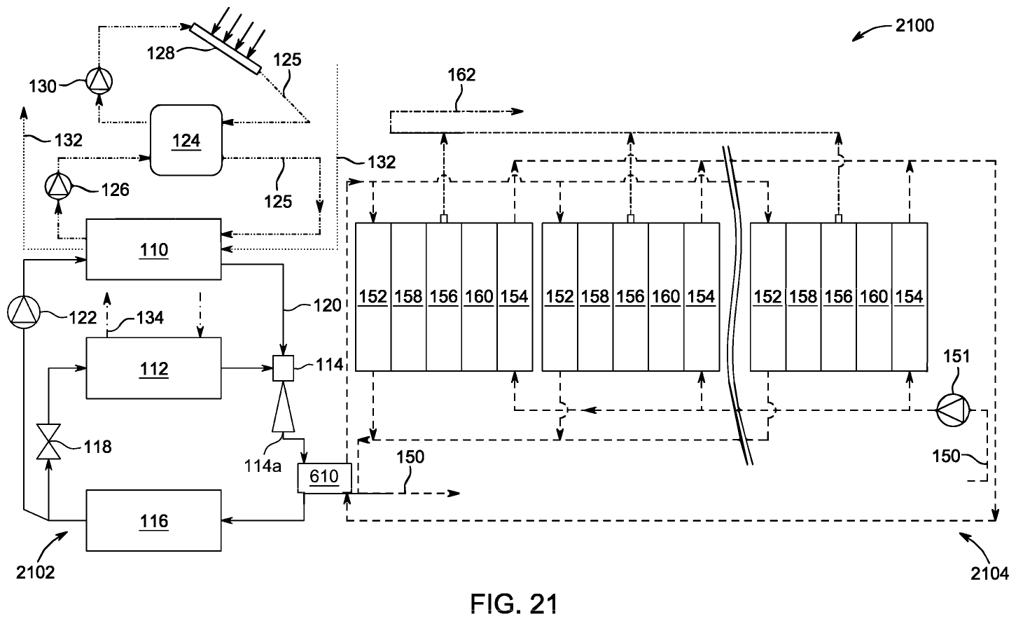

Referring to FIG. 21, illustrated is a schematic diagram of a desalination and cooling system 2100 having a multi-effect configuration, according to certain embodiments. The desalination and cooling system 2100 has many similarities with the desalination and cooling system 1800 depicted in FIG. 18, such as integrating an ECC system 2102 and an AGMD system 2104, combining principles of thermodynamic cycles and heat and mass transfer to produce freshwater and provide a cooling effect. The desalination and cooling system 2100 has the ECC system 2102 and the AGMD system 2104 with similar components to the desalination and cooling system 1800. These components interact, generally, in a similar manner across both systems, leveraging heat exchange and mass transfer processes to achieve the desired cooling and desalination outcomes. Further, the integration of the ECC system 2102 and the AGMD system 2104, the circulation of the feed stream 210, and the flow of the refrigerant 120 within the desalination and cooling system 2100 are similar to those in the desalination and cooling system 1800. Furthermore, the desalination and cooling system 2100, similar to the desalination and cooling system 1800, maintains fluid connection of the feed stream 210 in an open loop and employs the coolant chamber 154 of the AGMD system 2104 for pre-heating the feed stream 210. Also, the desalination and cooling system 2100 has the heater 610 located at the outlet 114a of the ejector 114 of the ECC system 2102, providing additional heating to the feed stream 150. Further, herein as well, the desalination and cooling system 2100 does not use the condenser 116 of the ECC system 1802 (at least directly) for heating the feed stream 150, but the heater 610 is solely and directly used for such purpose. However, as illustrated in FIG. 21, the desalination and cooling system 2100 introduces some distinct features in comparison to the desalination and cooling system 1800. These features of the desalination and cooling system 2100, which are detailed in the subsequent paragraph(s), cater to specific operational requirements or environmental conditions, thereby extending the versatility and applicability of the desalination and cooling system 2100.

A feature of the desalination and cooling system 2100, as illustrated in FIG. 21, is its multi-effect configuration. Specifically, in the desalination and cooling system 2100, the AGMD system 2104 has multi-effect configuration providing multiple AGMD units arranged in a staged manner, and each one including respective feed chamber 152, respective coolant chamber 154, respective air gap chamber 156, and respective membrane 158. These multiple stages offer the opportunity for progressive and incremental heating, vapor generation, and condensation, thereby enhancing the overall efficiency and productivity of the desalination process. It may be understood that the desalination and cooling system 2100 utilizes a single ECC system 2102. Herein, the AGMD system 2104 may have the multiple AGMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the AGMD system 2104. The multi-effect configuration provides the desalination and cooling system 2100 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple coolant chambers 154 allows for precise control over the temperature and flow rates at each stage, enhancing both the desalination and cooling efficiencies of the desalination and cooling system 2100.

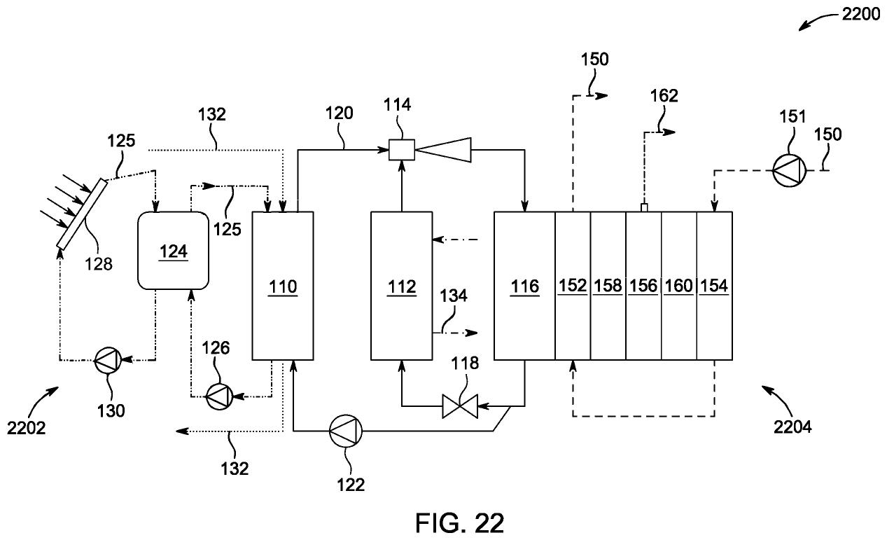

Referring to FIG. 22, illustrated is a schematic diagram of a desalination and cooling system 2200 having a single-effect configuration, according to certain embodiments. The desalination and cooling system 2200 integrates an ECC system 2202 and an AGMD system 2204 in a single-effect configuration, designed to provide efficient desalination and cooling functionalities. As with the previously discussed embodiments, the desalination and cooling system 2200 operates with the feed stream 150 to be treated that is fluidly connected in an open loop. The feed stream 150 initially undergoes pre-heating in the coolant chamber 154 of the AGMD system 2204. This pre-heating prepares the feed stream 150 for the subsequent distillation process and also ensures that the coolant chamber 154 provides the necessary low temperature to maintain the conditions for the AGMD system 2204. The ECC system 2202 in the desalination and cooling system 2200 includes components such as the generator 110, the ejector 114, and the condenser 116. The refrigerant 120 flows through these components in a cycle, absorbing and releasing heat energy, and thus generating a cooling effect.

A feature of the desalination and cooling system 2200, as illustrated in FIG. 22, is a direct contact heat exchange between the condenser 116 of the ECC system 2202 and the feed chamber 152 of the AGMD system 2204. This arrangement allows for the direct transfer of heat from the condenser 116 to the feed stream 150, thereby elevating its temperature. The heated feed stream 150 in the feed chamber 152 of the AGMD system 2202 may then produce water vapor at the interface with the membrane 158. The water vapor permeates across the pores of the membrane 158 and condenses in the air gap chamber 156 due to the cooler conditions maintained by the coolant chamber 154. The direct contact heat exchange between the condenser 116 and the feed chamber 152 enhances the heat transfer efficiency, leading to improved vapor generation and thus improved desalination efficiency. This feature also simplifies the configuration for the desalination and cooling system 2200, and reduces thermal losses, enhancing the overall energy efficiency of the desalination and cooling system 2200.

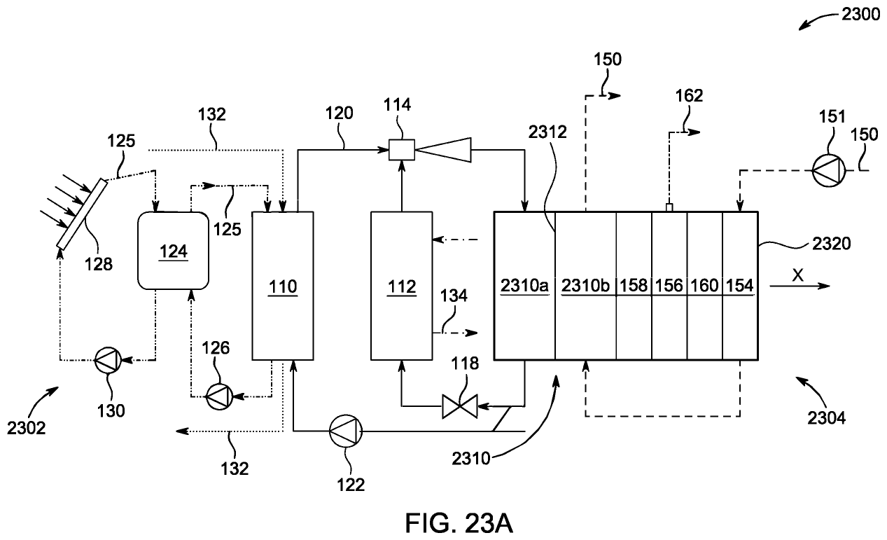

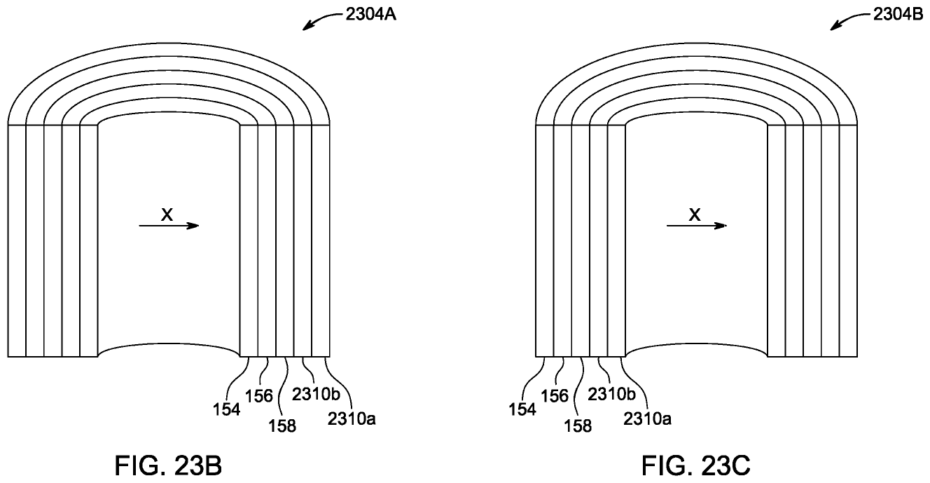

Referring to FIG. 23A, illustrated is a schematic diagram of a desalination and cooling system 2300 having a single-effect configuration, according to certain embodiments. The desalination and cooling system 2300 integrates an ECC system 2302 and an AGMD system 2304 in a single-effect configuration, designed to provide efficient desalination and cooling functionalities. As with the previously discussed embodiments, the desalination and cooling system 2300 operates with the feed stream 150 to be treated that is fluidly connected in an open loop. The feed stream 150 initially undergoes pre-heating in the coolant chamber 154 of the AGMD system 2304. This pre-heating prepares the feed stream 150 for the subsequent distillation process and also ensures that the coolant chamber 154 provides the necessary low temperature to maintain the conditions for the AGMD system 2304. In the ECC system 2304, the generator 110 is configured to generate the primary flow of the refrigerant 120. The evaporator 112 is configured to provide cooling and to generate the secondary flow of the refrigerant 120. The ejector 114 is configured for the primary and secondary flows of the refrigerant 120 to pass through and produce the super-heated stream of the refrigerant 120.

A feature of the desalination and cooling system 2300, as illustrated in FIG. 23A, is the design of a condenser 2310 as utilized in the ECC system 2302. The condenser 2310 is used to cool the super-heated stream of the refrigerant 120. The condenser 2310 includes a wall 2312 that separates a hot medium compartment 2310a and a cold medium compartment 2310b. The hot medium compartment 2310a is configured to receive the super-heated stream of the refrigerant 120. In the AGMD system 2304, the cold medium compartment 2310b of the condenser 2310 of the ECC system 2302 is configured to receive the feed stream 150 from the coolant chamber 154. The air gap chamber 156 is disposed between the cold medium compartment 2310b and the coolant chamber 154. The membrane 158, including a plurality of pores, is positioned between the cold medium compartment 2310b and the air gap chamber 156. The membrane 158 is configured to allow water vapors to pass from the cold medium compartment 2310b through the membrane 158 to the air gap chamber 156. This design of the condenser 2310 allows for efficient heat transfer between the hot medium compartment 2310a, which houses the super-heated stream of the refrigerant 120, and the cold medium compartment 2310b, which houses the feed stream 150. This direct heat exchange process results in the generation of water vapors from the feed stream 150, which then pass through the membrane 158 into the air gap chamber 156, providing an efficient process for water desalination.

Also, as illustrated in FIG. 23A, the desalination and cooling system 2300 further includes an enclosure 2320, that encompasses several components of the desalination and cooling system 2300. These components include the hot medium compartment 2310a, the cold medium compartment 2310b, the membrane 158, the air gap chamber 156, and the coolant chamber 154. The enclosure 2320 serves as a physical boundary that effectively houses and protects these components, ensuring their functioning and longevity. By consolidating these elements within the enclosure 2320, the desalination and cooling system 2300 benefits from a streamlined and compact design that makes it versatile and adaptable to a variety of installation environments.

Further, the enclosure 2320 is designed to not only protect the components but also to facilitate their interactions. For this purpose, the hot medium compartment 2310a, the cold medium compartment 2310b, the membrane 158, the air gap chamber 156, and the coolant chamber 154 are all arranged in succession within the enclosure 2320. This sequential arrangement allows the components to function in tandem, promoting the efficient flow and transfer of heat and mass within the desalination and cooling system 2300. The layout further ensures that the feed stream and the refrigerant traverse through the desalination and cooling system 2300 in a functional sequence, enabling the desalination and cooling system 2300 to perform its intended functions efficiently.

In particular, starting from the hot medium compartment 2310a, the super-heated stream of the refrigerant 120, generated by the ejector 114, enters the hot medium compartment 2310a and releases its heat, thereby cooling down. The heat is transferred across the wall 2312 to the cold medium compartment 2310b, where the feed stream 150 gets further heated, and water vapors are generated. These water vapors pass through the membrane 158 to reach the air gap chamber 156, where the vapors are condensed into liquid form, as the cold feed stream 150 entering the coolant chamber 154 absorbs the residual heat from the air gap chamber 156, thereby completing the desalination process. At the same time, the cold feed stream 150 gets pre-heated, thereby closing the loop and ensuring the efficient use of heat within the desalination and cooling system 2300. Thus, the enclosure 2320 having the sequential arrangement of the hot medium compartment 2310a, the cold medium compartment 2310b, the membrane 158, the air gap chamber 156, and the coolant chamber 154 therein, forms an efficient, self-contained unit for the desalination and cooling system 2300. This design ensures heat and mass transfer, thereby enhancing the overall energy efficiency of the desalination and cooling system 2300.

In certain embodiments, the AGMD system 2304, or specifically the enclosure 2320 has a geometrical configuration in which the coolant chamber 154, the air gap chamber 156, the membrane 158, the cold medium compartment 2310b, and the hot medium compartment 2310a are all cylindrical and concentrically arranged in succession along a radial direction ‘X’ (as shown). This concentric cylindrical arrangement improves surface area available for heat and mass transfer, thereby improving the efficiency of the AGMD system 2304. The cylindrical shape of the components also contributes to the compactness of the AGMD system 2304, allowing for a more flexible installation. Such design may be implemented in two different configurations. In a first configuration, the arrangement of these components starts from the innermost cylinder and expands outward. In the second configuration, the arrangement starts from the outermost cylinder and progresses inward.

FIG. 23B illustrates a cross-section diagram of the AGMD system (represented by reference numeral 2304A) for the desalination and cooling system 2300, according to the said first configuration. Herein, the coolant chamber 154 forms an inner cylinder, followed by the air gap chamber 156, the membrane 158, the cold medium compartment 2310b, and the hot medium compartment 2310a as an outer cylinder. This arrangement allows the feed stream 150 to be pre-heated by the coolant chamber 154 and then heated by the super-heated stream of the refrigerant 120 in various compartments moving radially outward from the coolant chamber 154 to the hot medium compartment 2310a.

FIG. 23C illustrates a cross-section diagram of the AGMD system (represented by reference numeral 2304B) for the desalination and cooling system 2300, according to the said second configuration. Herein, the hot medium compartment 2310a forms an inner cylinder, followed by the cold medium compartment 2310b, the membrane 158, the air gap chamber 156, and the coolant chamber 154 as an outer cylinder. This arrangement allows the feed stream 150 to be pre-heated by the coolant chamber 154 and then heated by the super-heated stream of the refrigerant 120 in various compartments moving radially inward from the coolant chamber 154 to the hot medium compartment 2310a.

Both configurations leverage the cylindrical and concentric design to ensure efficient heat and mass transfer for the functioning of the desalination and cooling system 2300. The choice between the two configurations may be determined based on specific application requirements, available space, and other design considerations.

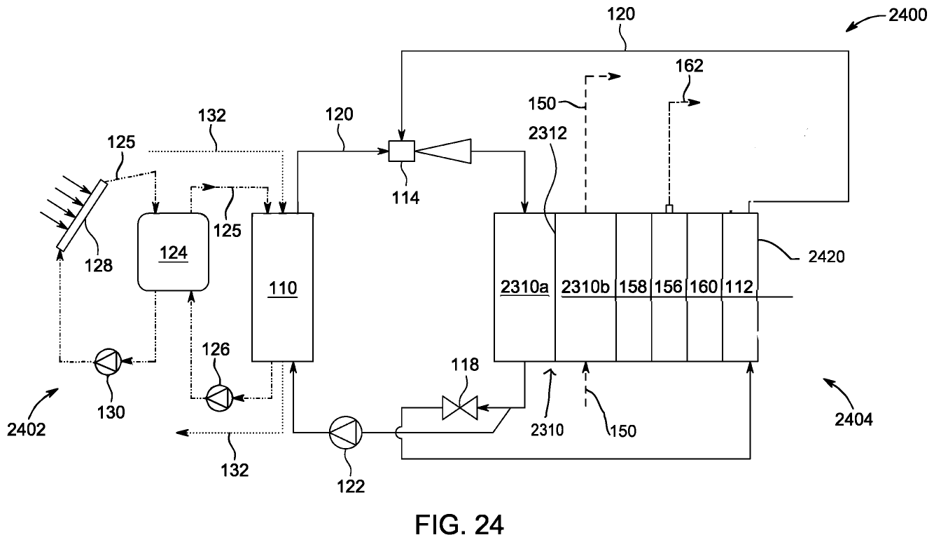

Referring to FIG. 24, illustrated is a schematic diagram of a desalination and cooling system 2400 having a single-effect configuration, according to certain embodiments. The desalination and cooling system 2400 integrates an ECC system 2402 and an AGMD system 2404 in a single-effect configuration, designed to provide efficient desalination and cooling functionalities. As with the previously discussed embodiments, the desalination and cooling system 2400 operates with the feed stream 150 to be treated that is fluidly connected in an open loop.

In the ECC system 2402, the condenser 2310 (as in FIG. 23A) is present that includes the hot medium compartment 2310a and the cold medium compartment 2310b. The cold medium compartment 2310b receives the feed stream 150 which exchanges heat with the super-heated stream of the refrigerant 120 entering the hot medium compartment 2310a. As a result, the feed stream 150 is heated while the super-heated stream of the refrigerant 120 is cooled down and condensed.

Herein, as illustrated, the desalination and cooling system 2400 incorporates the evaporator 112 of the ECC system 2402 with the AGMD system 2404, to provide the cooling effect therefor. In an example, the evaporator 112 may be part of an enclosure 2420 of the AGMD system 2404. Unlike the previously discussed embodiments, in the desalination and cooling system 2400, the cooling effect from the evaporator 112 is utilized directly to cool the cold wall 160 within the AGMD system 2404 or directly cool the gap chamber 156 when the cold wall 160 is not included in the AGMD system 2404. That is, the evaporator 112 absorbs heat from the cold wall 160 or from the gap chamber 156 to heat the refrigerant 120 to generate the secondary flow of the refrigerant 120. In other words, the evaporator 112 herein performs functions of both the evaporator 112 and the coolant chamber 154 in FIGS. 1 and 23A. In some embodiments, the feed stream 150 can pass through the evaporator 112 to be pre-heated before entering the cold medium compartment 2310b. The rest of the ECC system 2402 and the AGMD system 2404 may operate in the same manner as described earlier in the context of the previously discussed embodiments.

Similar to FIGS. 23A-23C, an enclosure 2420 herein, which corresponds to the enclosure 2320, can encompass several components of the desalination and cooling system 2400. These components include the hot medium compartment 2310a, the cold medium compartment 2310b, the membrane 158, the air gap chamber 156, the cold wall 160 (optional) and the evaporator 112. The enclosure 2420 can serve as a physical boundary that effectively houses and protect these components, ensuring their synergistic functioning and longevity. By consolidating these elements within the enclosure 2420, the desalination and cooling system 2400 benefits from a streamlined and compact design that makes it versatile and adaptable to a variety of installation environments.

Further, the enclosure 2420 is designed to not only protect the components but also to facilitate their interactions. For this purpose, the hot medium compartment 2310a, the cold medium compartment 2310b, the membrane 158, the air gap chamber 156, and the evaporator 112 are all arranged in succession within the enclosure 2420. This sequential arrangement allows the components to function in tandem, promoting the efficient flow and transfer of heat and mass within the desalination and cooling system 2400 while reducing the number of inlets, outlets and/or connecting pipes. The layout further ensures that the feed stream 150 and the refrigerant 120 traverse through the desalination and cooling system 2400 in an optimal sequence, enabling the desalination and cooling system 2400 to perform its intended functions efficiently.

In one embodiment, the AGMD system 2404 for the desalination and cooling system 2400 can be similar to the numeral 2304A in FIG. 23B and are not shown for simplicity purposes. That is, the evaporator 112 forms an inner cylinder, followed by the cold wall (optional), the air gap chamber 156, the membrane 158, the cold medium compartment 2310b, and the hot medium compartment 2310a as an outer cylinder.

In another embodiment, the AGMD system 2404 for the desalination and cooling system 2400 can be similar to the numeral 2304B in FIG. 23C and are not shown for simplicity purposes. That is, the hot medium compartment 2310a forms an inner cylinder, followed by the cold medium compartment 2310b, the membrane 158, the air gap chamber 156, the cold wall (optional) and the evaporator 112 as an outer cylinder.

The present disclosure further provides experimental data obtained from testing the desalination and cooling system 100 of FIG. 1 (taken as reference) as per embodiments of the present disclosure. The experimental setup was modeled based on the desalination and cooling system 100, which shows the ECC system 102 hybridized with the AGMD system 104.

In some embodiments, the membrane 158 has an effective area of 0.1-1.0 m², preferably 0.3-0.8 m², preferably 0.4-0.6 m², a mean pore size of 0.1-1.0 μm, preferably 0.3-0.8 μm, preferably 0.4-0.6 μm, a thickness of 100-200 μm, preferably 120-180 μm, preferably 140-160 μm, and a porosity of 60-99%, preferably 70-90%, preferably 75-85%.

In one experimental setup, the waste heat from the condenser 116 is recovered and utilized to elevate the temperature of the intake feed stream 150. The membrane 158 used in this model has an effective area of 0.5 m² and a mean pore size of 0.45 μm. Thickness and porosity of the membrane 158 are assumed to be 153 μm and 80%, respectively. The feed chamber 152 and the air gap chamber 156 of the AGMD system 104 can be of equal dimensions, measuring 0.5-3.0 m, preferably 0.7-2.0 m, preferably 1 m in length, 0.2-1.0 m, preferably 0.4-0.7 m, preferably 0.5 m in width, and 0.0001-0.0080 m, preferably 0.0005-0.0020 m, preferably 0.001 m in depth. An air gap width as provided by the air gap chamber 156 is fixed at 1-5 mm, preferably 2-4 mm, preferably 3 mm. The feed stream 150 to be treated is assumed to have a salinity of 10,000-60,000 mg/L, preferably 20,000-40,000 mg/L, preferably 35,000 mg/L. Flow rates of the feed stream 150 and the coolant stream 164 are respectively selected to be 0.4-6 L/min, preferably 0.7-3 L/min, preferably 1 L/min. Initial temperature of the feed stream 150 is assumed to be 5-50° C., preferably 20-35° C., preferably 27° C., and maximum temperature of the feed stream 150 after heating in the condenser 116 depends on the type of refrigerant used in the ECC system 102. Further, temperature of the coolant stream 164 is fixed at 5-23° C., preferably 10-22° C., preferably 20° C. Effectiveness of the condenser 116 is assumed to be 70-100%, preferably 80-95%, preferably 90%, and each pump has an assumed efficiency of 70-100%, preferably 80-95%, preferably 90%. Further, temperature of the evaporator 112 is 5-20° C., preferably 8-15° C., preferably 12° C. Temperature of the generator 110 is 70-150° C., preferably 80-130° C., preferably 90° C. Temperature of the first condenser 116 is 20-50° C., preferably 30-40° C., preferably 34.2° C. The performance of the desalination and cooling system 100 is evaluated in terms of gained output ratio (GOR), and energy utilization factor (EUF), productivity, and cooling effect.

Herein, the GOR is calculated as the ratio of the latent heat of vaporization of the produced freshwater 162 to the sum of input energy to the generator 110 and energy consumed by the pumps. The GOR of the desalination and cooling system 100 represents the energy efficiency of the standalone AGMD system and can be expressed as:

$$GOR = \frac{{\dot{Q}}_{AGMD , useful}}{{\dot{Q}}_{Generator} + {\dot{W}}_{Pumps}} \qquad ( 1 )$$

Further, useful energy in the AGMD system 104 is related to the evaporation process, and can be expressed as:

$${\dot{Q}}_{AGMD , useful} = J \times Δ {H}_{v} \times {A}_{m} \qquad ( 2 )$$

where J, ΔHᵥ, and Aₘ is the AGMD permeate flux (kg/m²h), latent heat of vaporization (kJ/kg), and membrane active area, respectively.

Also, the EUF is calculated as the ratio of the sum of the latent heat of vaporization of the produced freshwater 162 and the cooling effect 134 in the evaporator 112 to the sum of the input energy to the generator 110 and the energy consumed by the pumps. The EUF of the desalination and cooling system 100 represents its energy efficiency and can be given as:

$$EUF = \frac{{\dot{Q}}_{AGMD , useful} + {\dot{Q}}_{Evaporator}}{{\dot{Q}}_{Generator} + {\dot{W}}_{Pumps}} \qquad ( 3 )$$

Further, the productivity of the desalination and cooling system 100 is the freshwater 162 produced (L/day) by the AGMD system 104 therein, while the cooling effect of the desalination and cooling system 100 is the cooling effect 134 (refrigeration load) (in W) produced in the evaporator 112 of the ECC system 102 therein.

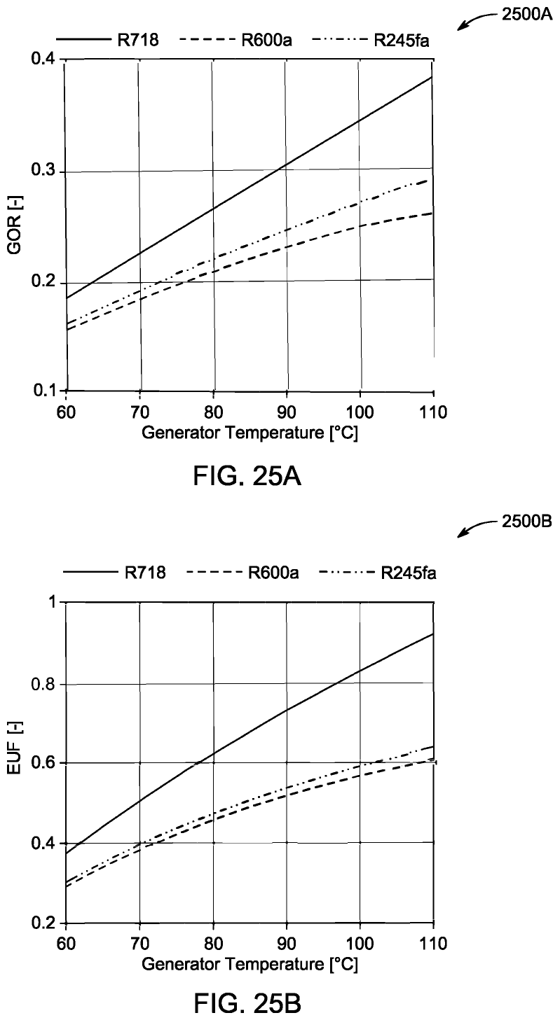

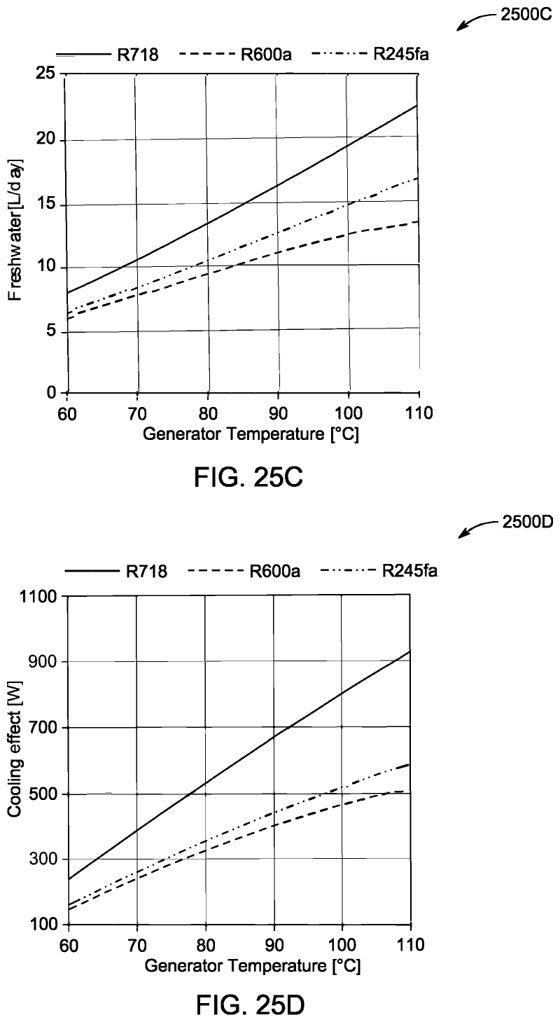

Referring to FIGS. 25A-25D, illustrated are graphs 2500A-2500D representing the GOR, the EUF, the freshwater produced and the cooling effect produced, respectively, for evaluating the performance of the desalination and cooling system 100 at different temperatures of the generator 110 of the ECC system 102 therein. The graph 2500A shows the GOR, demonstrating that as temperature of the generator 110 increases, the GOR also increases for different refrigerants used in the cycle. The GOR, indicative of the energy efficiency of the standalone AGMD system, achieves its highest value of 0.3847 at a temperature of the generator 110 of 110° C. with the R718 refrigerant. The graph 2500B shows the EUF, which also increases with the rise in the temperature of the generator 110. The EUF, which represents the energy efficiency of the desalination and cooling system 100, peaks at 0.9182 with the R718 refrigerant at a temperature of the generator 110 of 110° C. The graph 2500C shows the freshwater production of the desalination and cooling system 100, which also increases with the temperature of the generator 110. The desalination and cooling system 100 reaches its highest freshwater production of 22.38 L/day at a temperature of the generator 110 of 110° C. with the R718 refrigerant. The graph 2500D shows the cooling effect produced by the desalination and cooling system 100, which increases as the temperature of the generator 110 increases. The maximum cooling effect, 924.4 W, is achieved at a temperature of the generator 110 of 110° C. using the R718 refrigerant.

It may be noted that the integration of the AGMD system 104 with the ECC system 102 enhances energy efficiency of the AGMD system 104 in the desalination and cooling system 100 by 138% when compared to the standalone AGMD system, as indicated by the maximum GOR and EUF. The R718 refrigerant yields superior performance due to its ability to recover more waste heat from the condenser 116 of the ECC system 102. This increased recovery results in a higher transmembrane temperature in the AGMD system 104, which in turn leads to a higher driving force for vapor permeation, increased water flux, and consequently, improved energy efficiency of the desalination and cooling system 100.

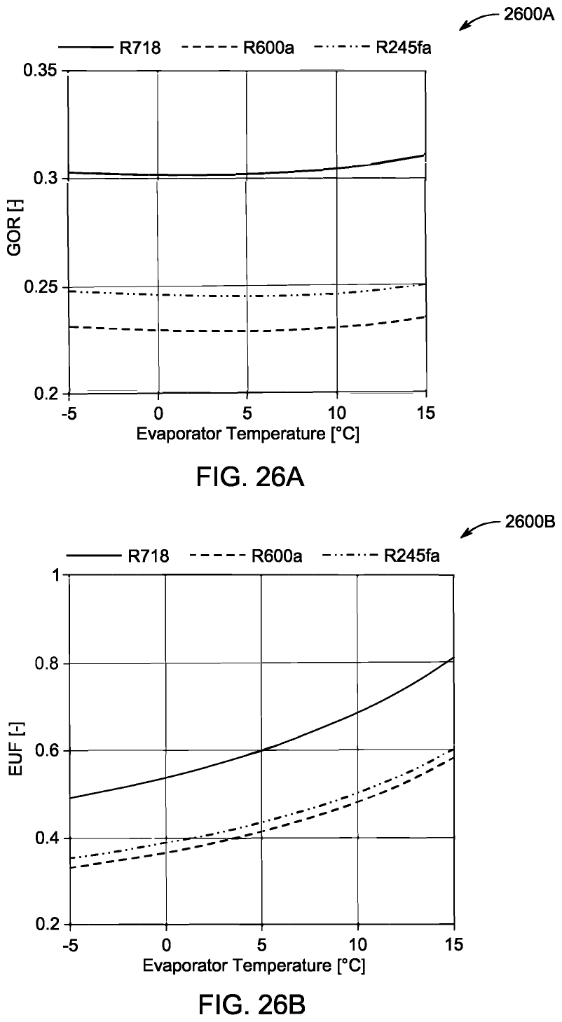

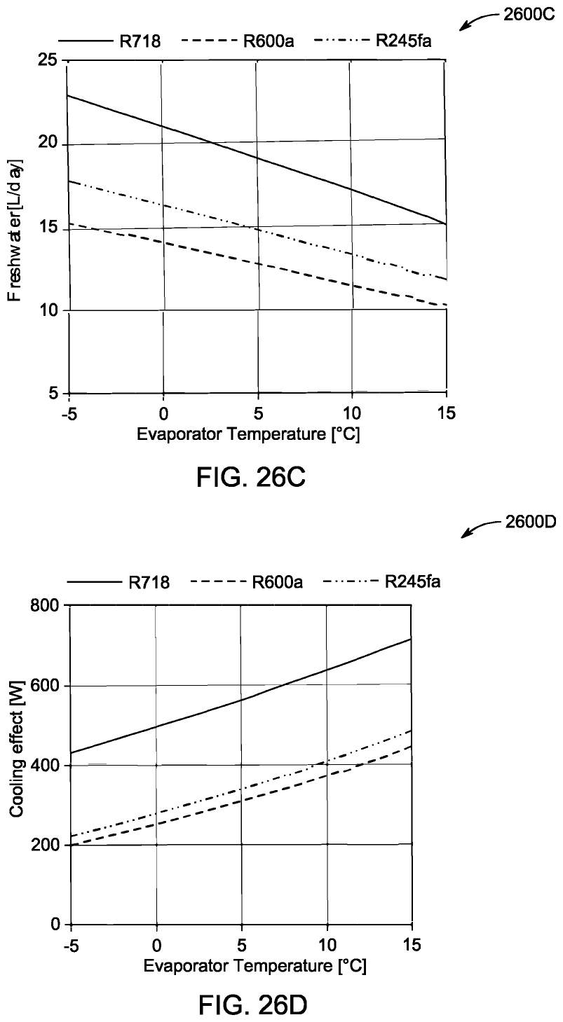

Referring to FIGS. 26A-26D, illustrated are graphs 2600A-2600D depicting the GOR, EUF, freshwater production, and cooling effect, respectively, for the evaluation of the performance of the desalination and cooling system 100 at different temperatures of the evaporator 112 in the ECC system 102. The graph 2600A shows the GOR, which slightly increases as the temperature of the evaporator 112 increases. The desalination and cooling system 100 attains a reasonable GOR of 0.3105 at a temperature of 15° C. of the evaporator 112, showcasing the efficiency of the standalone AGMD system under different conditions. The graph 2600B shows that the EUF increases with the rise in the temperature of the evaporator 112. The EUF, representative of the energy efficiency of the desalination and cooling system 100, peaks at 0.8083 with the R718 refrigerant at a temperature of the evaporator 112 of 15° C. The graph 2600C shows a decrease in the freshwater production rate of the desalination and cooling system 100 with the rise in the temperature of the evaporator 112. Nevertheless, the desalination and cooling system 100 achieves a maximum productivity of 22.9 L/day. The graph 2600D shows the cooling effect produced by the desalination and cooling system 100, which increases as the temperature of the evaporator 112 rises. The highest cooling effect of 711.6 W is achieved with the R718 refrigerant at a temperature of the evaporator 112 of 15° C.

It may be noted that integrating the AGMD system 104 with the ECC system 102 enhances energy efficiency of the AGMD system 104 in the desalination and cooling system 100 by over 160% when compared to the standalone AGMD system. This improvement is observed for the R718 refrigerant at different temperatures of the evaporator 112. The R718 refrigerant exhibits superior performance due to its ability to recover more waste heat from the condenser 116 of the ECC system 102. This increased recovery results in a higher transmembrane temperature in the AGMD system 104, leading to a higher driving force for vapor permeation, increased water flux, and consequently, improved energy efficiency of the desalination and cooling system 100.

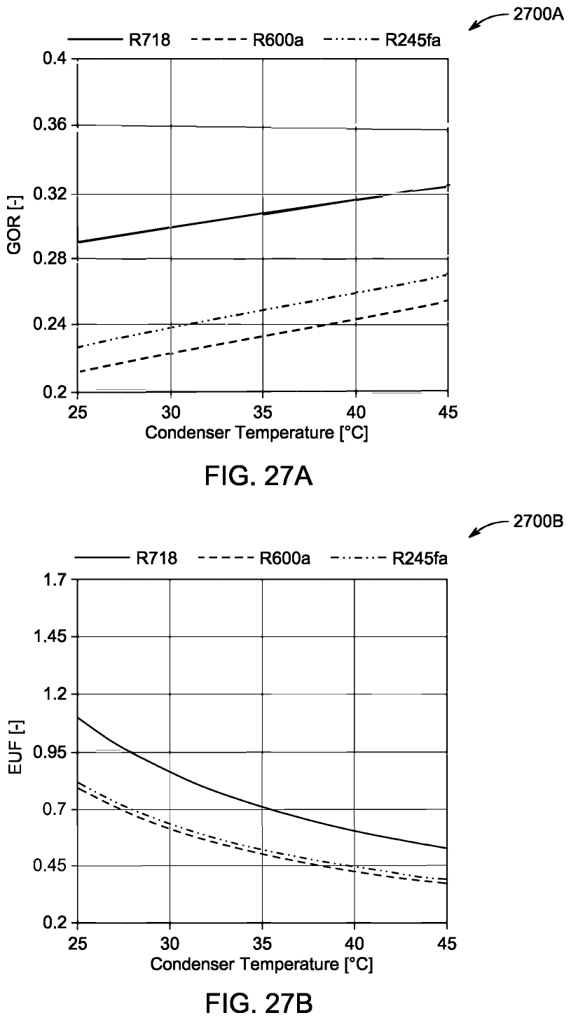

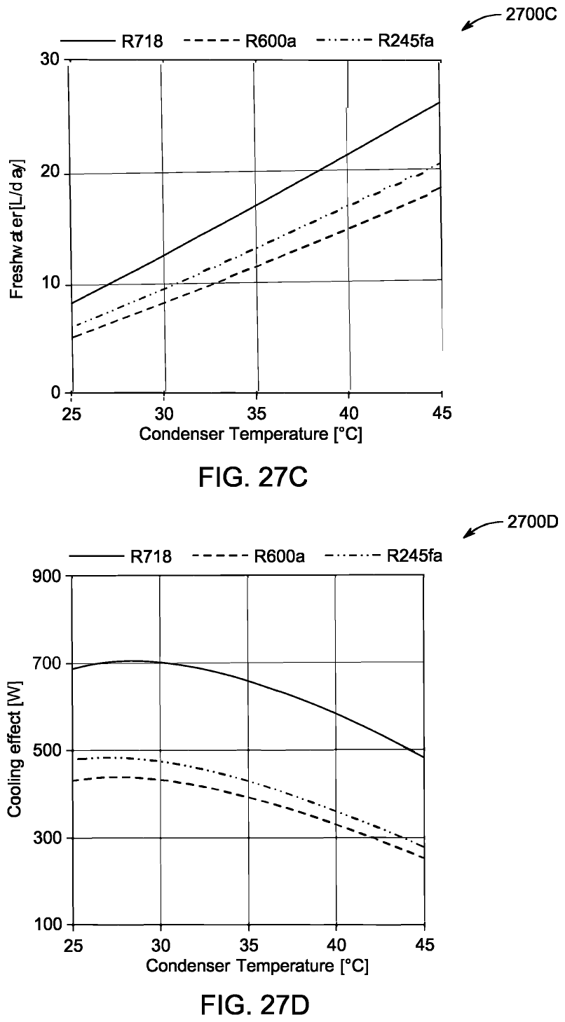

Referring to FIGS. 27A-27D, depicted are graphs 2700A-2700D illustrating the GOR, EUF, freshwater production, and cooling effect respectively, for evaluating the performance of the desalination and cooling system 100 at different temperatures of the condenser 116 in the ECC system 102. The graph 2700A shows the GOR, which increases as the temperature of the condenser 116 rises, the GOR maxes out 0.3242, reflecting enhanced energy efficiency of the standalone AGMD system under different conditions. The graph 2700B shows that the EUF decreases with the increase in the temperature of the condenser 116, indicating a decrease in energy efficiency of the desalination and cooling system 100. The desalination and cooling system 100 attained a maximum EUF od 1.08 at an approx. temperature of 27° C. of the condenser 116. The graph 2700C shows an increase in the freshwater production rate of the desalination and cooling system 100 with the rise in the temperature of the condenser 116. The desalination and cooling system 100 achieves a maximum productivity of 25.99 L/day, when using the R718 refrigerant. The graph 2700D shows the cooling effect produced by the desalination and cooling system 100, which initially increases and then decreases with the rise in the temperature of the condenser 116. The highest cooling effect, 701.8 W, is achieved at a temperature of the condenser 116 of approximately 27° C. using the R718 refrigerant.

It may be noted that the integration of the AGMD system 104 with the ECC system 102 enhances energy efficiency of the AGMD system 104 in the desalination and cooling system 100 by over 272% when compared to the standalone AGMD system, as indicated by the highest recorded GOR and EUF values. This improvement is observed for the R718 refrigerant at different temperatures of the condenser 116. The R718 refrigerant demonstrates superior performance due to its capability to recover more waste heat from the condenser 116 of the ECC system 102. This increased recovery results in a higher transmembrane temperature in the AGMD system 104, leading to a higher driving force for vapor permeation, increased water flux, and consequently, improved energy efficiency of the desalination and cooling system 100.

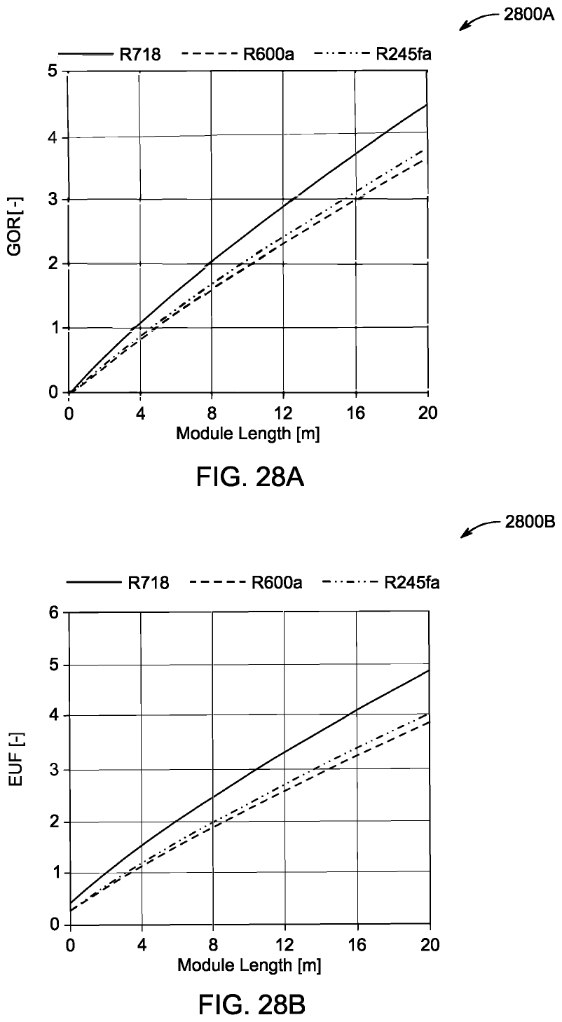

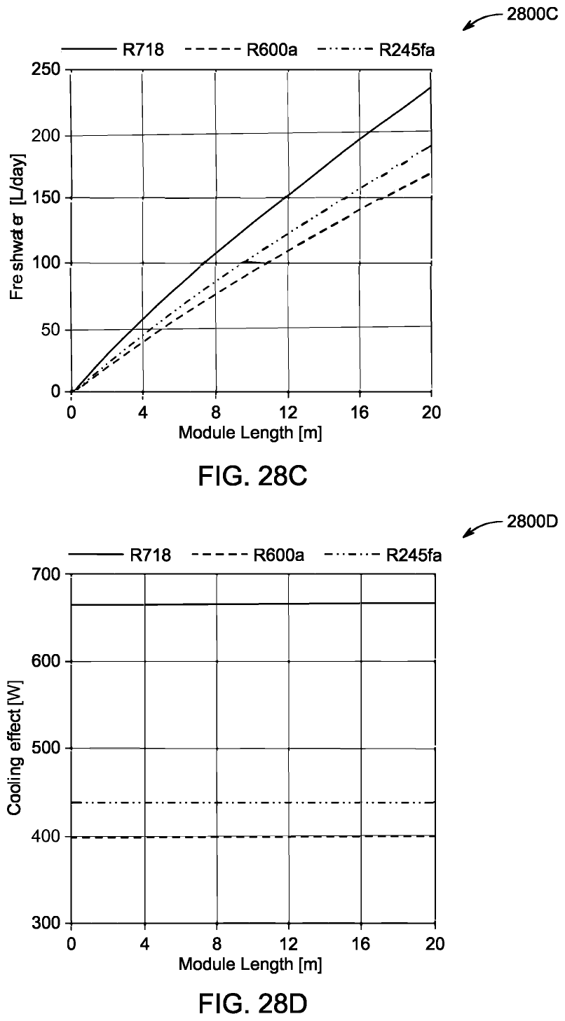

Referring to FIGS. 28A-28D, depicted are graphs 2800A-2800D illustrating the GOR, EUF, freshwater production, and cooling effect, respectively, for evaluating the performance of the desalination and cooling system 100 at increasing module length of the AGMD system 104. The graph 2800A shows the GOR, which increase as feed stream 150 temperature increases. The AGMD system 104 under different conditions attains a highest GOR of 4.429 achieved at a module length of 20 m of the AGMD system 104 using the R718 refrigerant. The graph 2800B shows that the EUF also increases with the increase in the module length of the AGMD system 104. The AGMD system, 104 under different conditions, attains a highest EUF of 4.852 at a module length of 20 m of the AGMD system 104. The graph 2800C shows an increase in the freshwater 162 production rate of the desalination and cooling system 100 with the increase in the module length of the AGMD system 104. The desalination and cooling system 100 achieves a maximum productivity of 234.6 L/day at a module length od 20 m of the AGMD system 104, using the R718 refrigerant. The graph 2800D shows the cooling effect produced by the desalination and cooling system 100, which remains constant at 665.4 W, as the module length of the AGMD system 104 is increased as the module length variation has no effect on the ECC system 102.

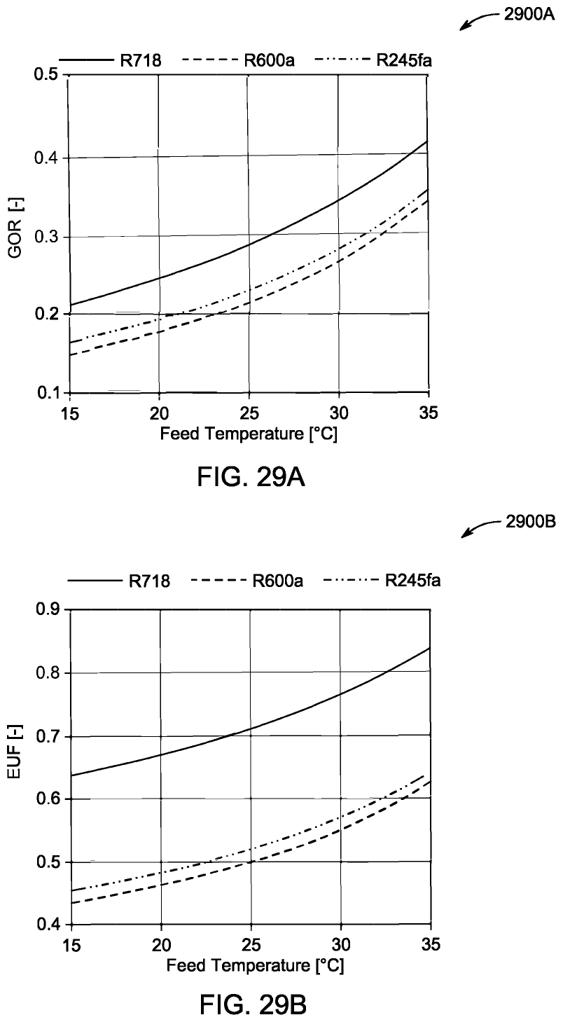

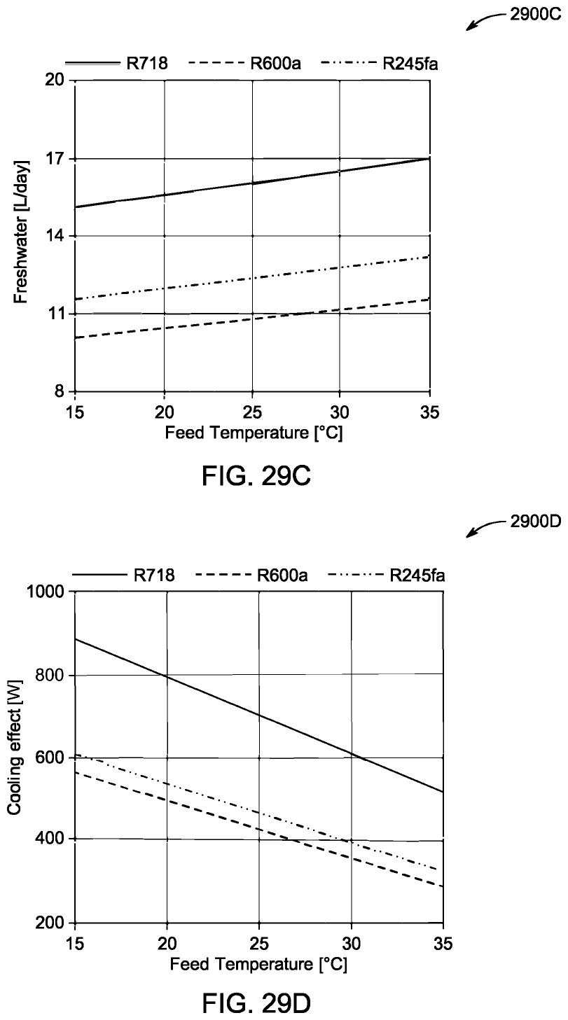

Referring to FIGS. 29A-29D, depicted are graphs 2900A-2900D illustrating the GOR, EUF, freshwater production, and cooling effect, respectively, for evaluating the performance of the desalination and cooling system 100 at different temperatures of the feed stream 150. The graph 2900A shows the GOR, which improves with the rise in the temperature of the feed stream 150, reflecting enhanced energy efficiency under different conditions. The desalination and cooling system 100 reaches its highest GOR of 0.4131 at a higher temperature of the feed stream 150 when using the R718 refrigerant. The graph 2800B shows the EUF, which also improves with the increase in the temperature of the feed stream 150. The EUF, representative of the energy efficiency of the desalination and cooling system 100, peaks at 0.8361 at a higher temperature of the feed stream 150 with the R718 refrigerant. The graph 2800C shows the freshwater production, which slightly improves as the temperature of the feed stream 150 rises. The desalination and cooling system 100 achieves a maximum productivity of 16.97 L/day, when using the R718 refrigerant. The graph 2800D shows the cooling effect produced by the desalination and cooling system 100, which declines as the temperature of the feed stream 150 increases. Despite this decrease, the desalination and cooling system 100 still attains a substantial cooling effect, with the maximum cooling effect, 888.9 W, achieved at a lower temperature of the feed stream 150 using the R718 refrigerant.

It may be noted that the integration of the AGMD system 104 with the ECC system 102 enhances energy efficiency of the AGMD system 104 in the desalination and cooling system 100 by over 47% when compared to the standalone AGMD system, as indicated by the highest recorded GOR and EUF values. This improvement is observed for the R718 refrigerant at different temperatures of the feed stream 150. The R718 refrigerant demonstrates superior performance due to its capability to recover more waste heat from the condenser 116 of the ECC system 102. This increased recovery results in a higher transmembrane temperature in the AGMD system 104, leading to a higher driving force for vapor permeation, increased water flux, and consequently, improved energy efficiency of the desalination and cooling system 100.

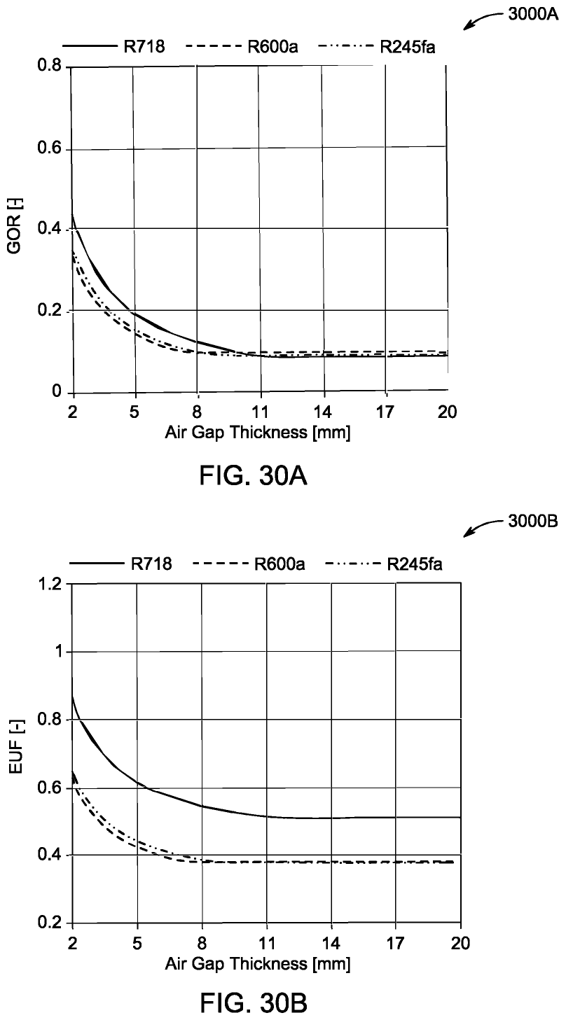

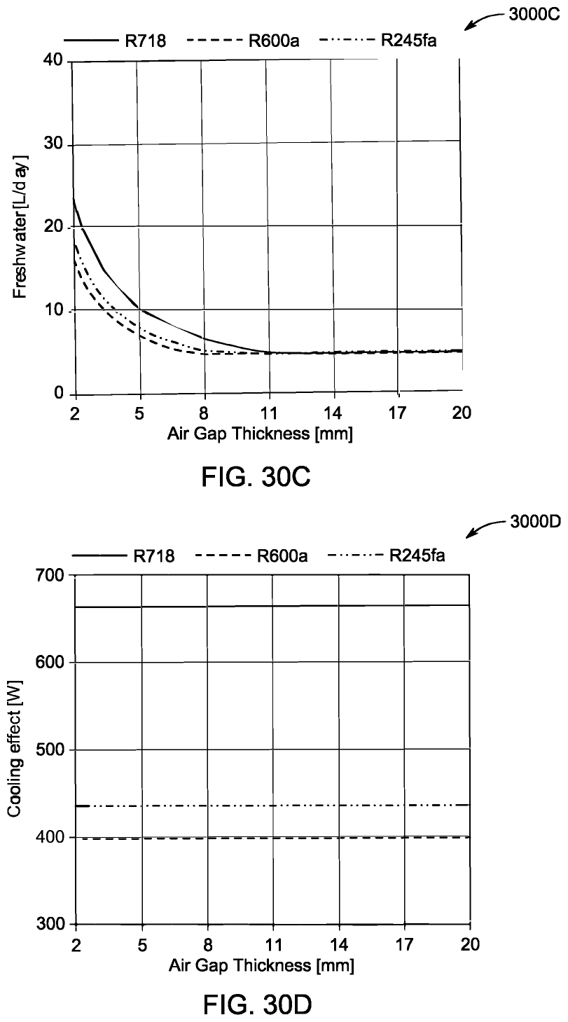

Referring to FIGS. 30A-30D, depicted are graphs 3000A-3000D illustrating the GOR, EUF, freshwater production, and cooling effect, respectively, for evaluating the performance of the desalination and cooling system 100 at different air gap thicknesses of the air gap chamber 156. The graph 3000A shows the GOR, which decreases as the air gap thickness of the air gap chamber 156 increases. Despite this decrease, the AGMD system 104 under different conditions still attains a reasonable GOR, with the highest GOR of 0.358 achieved at an air gap thickness of 2 mm using the R718 refrigerant. The graph 3000B shows that the EUF also decreases with the increase in the thickness of the air gap chamber 156. The EUF, which represents the energy efficiency of the desalination and cooling system 100, peaks at 0.8641 at an air gap thickness of 2 mm with the R718 refrigerant. The graph 3000C shows a decrease in the freshwater production rate of the desalination and cooling system 100 with the increase in the thickness of the air gap chamber 156. Despite this decrease, the desalination and cooling system 100 achieves a maximum productivity of 23.35 L/day at an air gap thickness of 2 mm using the R718 refrigerant. The graph 3000D shows the cooling effect produced by the desalination and cooling system 100, which remains constant at 665.4 W, as the thickness of the air gap chamber 156 increases.

It may be noted from the observations of the graphs 3000A-3000D, that increasing the air gap thickness of the air gap chamber 156 from 2 mm to 20 mm using the R718 refrigerant leads to a decrease in productivity of the desalination and cooling system 100 from 23.35 L/day to 4.58 L/day. Further, the GOR and EUF of the desalination and cooling system 100 decrease from 0.358 to 0.090 and 0.8641 to 0.509, respectively. This decrease in efficiency and productivity can be attributed to the increased resistance to heat and mass transfer at larger air gap thicknesses, which leads to lower productivity of the desalination and cooling system 100. Therefore, for increasing the productivity of the desalination and cooling system 100, air gap thickness of the air gap chamber 156 could be reduced.

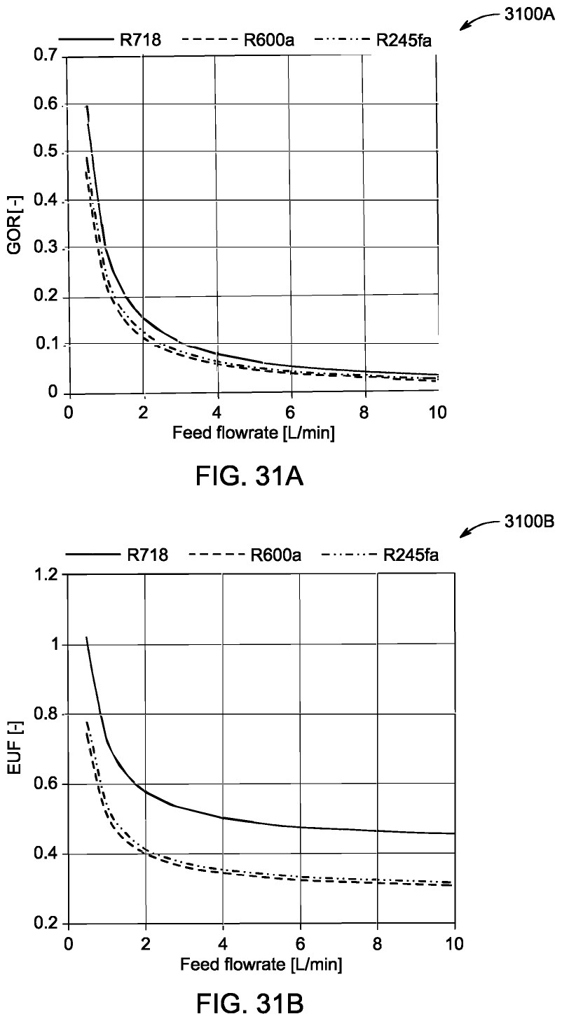

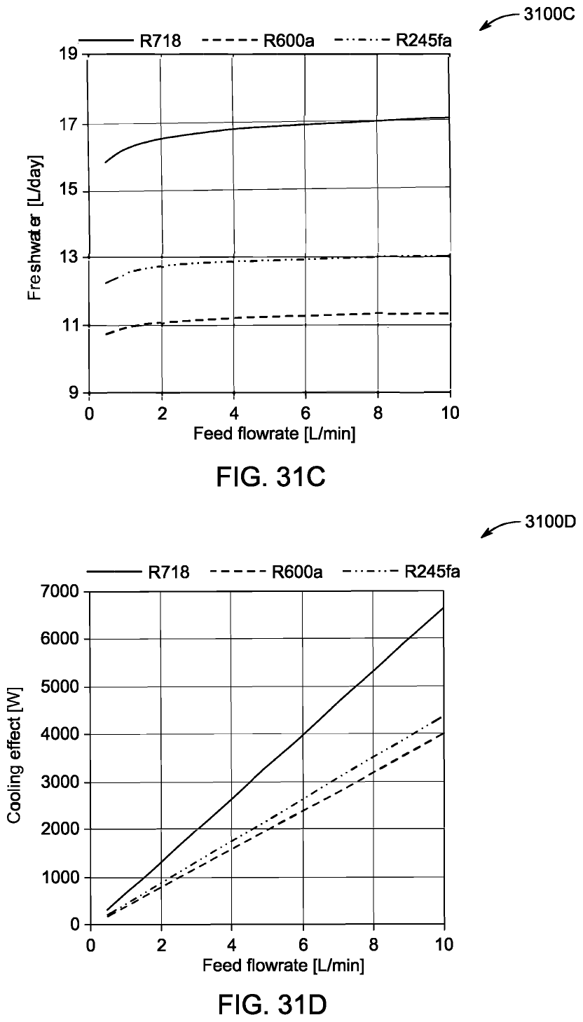

Referring to FIGS. 31A-31D, depicted are graphs 3100A-3100D illustrating the GOR, EUF, freshwater production, and cooling effect, respectively, for evaluating the performance of the desalination and cooling system 100 at different flowrates of the feed stream 150. The graph 3100A shows the GOR, which decreases as the flowrate of the feed stream 150 increases. Despite this decrease, the AGMD system 104 under different conditions still attains a reasonable GOR, with the highest GOR of 0.6 achieved at a flowrate of the feed stream 150 of 0.5 L/min using the R718 refrigerant. The graph 3100B shows that the EUF also decreases with the increase in the flowrate of the feed stream 150. The EUF, which represents the energy efficiency of the desalination and cooling system 100, peaks at 1.02 at a flowrate of the feed stream 150 of 0.5 L/min with the R718 refrigerant. The graph 3100C shows an increase in the freshwater production rate of the desalination and cooling system 100 with the increase in the flowrate of the feed stream 150. The desalination and cooling system 100 achieves a maximum productivity of 17 L/day at a flowrate of the feed stream 150 of 10 L/min using the R718 refrigerant. The graph 3100D shows the cooling effect produced by the desalination and cooling system 100, which increases as the flowrate of the feed stream 150 rises. The highest cooling effect, 6.6 kW, is achieved at a flowrate of the feed stream 150 of 10 L/min using the R718 refrigerant.

It may be noted that from the observations of the graphs 3100A-3100D, that increasing the flowrate of the feed stream 150 from 0.5 L/min to 10 L/min using the R718 refrigerant leads to an increase in productivity of the desalination and cooling system 100 from 15.87 L/day to 17 L/day and the cooling load from 0.2 kW to 6.6 kW. However, the GOR and the EUF of the desalination and cooling system 100 decrease from 0.5 to 0.32 and 1.02 to 0.455, respectively. These changes can be attributed to the increased heat and mass transfer at higher flowrates of the feed stream 150, which enhances the cooling effect and freshwater productivity.

The desalination and cooling system(s) 100-2400 proposed in the present disclosure may find wide-ranging applications across various industries, as well as in specific processes requiring water treatment and temperature regulation. The system may be employed to desalinate seawater, thereby producing freshwater for various uses, including drinking, irrigation, and industrial processes. The system may be used for the purification of water used in textile manufacturing processes, aiding in the removal of dyes and other contaminants. The system may play a crucial role in the purification of water used in chemical synthesis and pharmaceutical production, helping maintain the purity of the products and adhere to stringent regulations. In the food industry, the system may be used in processes such as milk processing and fruit juice concentration, by aiding in the removal of impurities, ensuring the safety and quality of the products. The system may be used in biomedical applications such as the removal of pure water from blood and protein solutions, supporting research and development in the healthcare sector. The system may also be utilized in the separation of azeotropic aqueous mixtures, such as the separation of alcohol and water mixtures, enhancing the efficiency of industrial processes. The system may find applications in brine mining and in processes that require zero liquid discharge, contributing to resource conservation and environmental protection. The system may also be deployed in applications where high-temperature processing causes thermal degradation of the process flow, providing a solution that balances temperature regulation and efficient operation. More generally, the system may be used for the treatment of wastewater, reducing environmental impact and aiding in sustainability efforts.

Numerous modifications and variations of the present disclosure are possible in light of the above teachings. It is therefore to be understood that within the scope of the appended claims, the present invention may be practiced otherwise than as specifically described herein.

1. A desalination and cooling system, comprising:
an ejector cooling cycle (ECC) system comprising
a generator configured to generate a primary flow of a refrigerant,
an evaporator configured to provide cooling and provide a secondary flow of the refrigerant,
an ejector configured for the primary flow and the secondary flow to pass through to obtain a super-heated stream of the refrigerant, and
a condenser configured to cool the super-heated stream of the refrigerant; and
an air gap membrane distillation (AGMD) system comprising
a feed chamber configured to receive a hot stream comprising water,
a coolant chamber configured to receive a cold stream comprising water,
an air gap chamber disposed between the feed chamber and the coolant chamber, and
a membrane disposed between the feed chamber and the air gap chamber, the membrane comprising a plurality of pores configured to allow water vapors originating from the hot stream to pass from the feed chamber through the membrane to the air gap chamber,
wherein the ECC system and the AGMD system are connected at the condenser so that the cold stream is heated by the super-heated stream of the refrigerant at the condenser to produce the hot stream.

2. The desalination and cooling system of claim 1, wherein the coolant chamber and the air gap chamber are configured to allow heat exchange so that the coolant chamber pre-heats the cold stream.

3. The desalination and cooling system of claim 2, wherein an outlet of the evaporator is connected to an inlet of the coolant chamber so that the evaporator is configured to provide cooling for the cold stream before the cold stream enters the coolant chamber.

4. The desalination and cooling system of claim 1, wherein the ECC system further comprises a heater that is configured to provide heat for the generator to generate the primary flow of the refrigerant.

5. The desalination and cooling system of claim 4, wherein the heater is configured to further heat the hot stream after the condenser and before the feed chamber.

6. The desalination and cooling system of claim 1, wherein the AGMD system further comprises a cold wall disposed between the coolant chamber and the air gap chamber.

7. The desalination and cooling system of claim 1, wherein the ECC system further comprises a heater that is configured to further heat the super-heated stream of the refrigerant before the super-heated stream of the refrigerant enters the condenser.

8. The desalination and cooling system of claim 1, wherein the AGMD system is a multi-effect distillation system.

9. The desalination and cooling system of claim 1, further comprising an external chiller that is configured to cool the cold stream before the cold stream enters the coolant chamber.

10. The desalination and cooling system of claim 1, wherein the ECC system further comprises a solar collector that is configured to provide heat for the generator to generate the primary flow of the refrigerant.

11. A desalination and cooling system, comprising:
an ejector cooling cycle (ECC) system comprising
a generator configured to generate a primary flow of a refrigerant,
an evaporator configured to provide cooling and provide a secondary flow of the refrigerant,
an ejector configured for the primary flow and the secondary flow to pass through to obtain a super-heated stream of the refrigerant, and
a condenser configured to cool the super-heated stream of the refrigerant, the condenser comprising a wall separating a hot medium compartment and a cold medium compartment, the hot medium compartment configured to receive the super-heated stream of the refrigerant; and
an air gap membrane distillation (AGMD) system comprising
a coolant chamber configured to receive a feed stream comprising water,
the cold medium compartment of the condenser of the ECC system configured to receive the feed stream from the coolant chamber,
an air gap chamber disposed between the cold medium compartment and the coolant chamber, and
a membrane disposed between the cold medium compartment and the air gap chamber, the membrane comprising a plurality of pores configured to allow water vapors to pass from the cold medium compartment through the membrane to the air gap chamber,
wherein the ECC system and the AGMD system are connected at the condenser so that the feed stream, in the cold medium compartment of the condenser, is heated by the super-heated stream of the refrigerant to generate the water vapors.

12. The desalination and cooling system of claim 11, further comprising an enclosure that houses the hot medium compartment, the cold medium compartment, the membrane, the air gap chamber and the coolant chamber.

13. The desalination and cooling system of claim 12, wherein the hot medium compartment, the cold medium compartment, the membrane, the air gap chamber and the coolant chamber are arranged in succession in the enclosure.

14. The desalination and cooling system of claim 11, wherein:
the generator, the ejector and the condenser are configured to define a power cycle of the ECC system, and
the evaporator, the ejector and the condenser are configured to define a refrigeration cycle of the ECC system.

15. The desalination and cooling system of claim 11, wherein the coolant chamber and the air gap chamber are configured to allow heat exchange so that the coolant chamber pre-heats the feed stream.

16. The desalination and cooling system of claim 15, wherein an outlet of the evaporator is connected to an inlet of the coolant chamber so that the evaporator is configured to provide cooling for the feed stream before the feed stream enters the coolant chamber.

17. The desalination and cooling system of claim 11, wherein the ECC system further comprises a heater that is configured to provide heat for the generator to generate the primary flow of the refrigerant.

18. The desalination and cooling system of claim 11, wherein the AGMD system further comprises a cold wall disposed between the coolant chamber and the air gap chamber.

19. The desalination and cooling system of claim 11, wherein the ECC system further comprises a heater that is configured to further heat the super-heated stream of the refrigerant before the super-heated stream of the refrigerant enters the condenser.

20. The desalination and cooling system of claim 11, wherein the coolant chamber, the air gap chamber, the membrane, the cold medium compartment, and the hot medium compartment are cylindrical and concentrical and are arranged in succession along a radial direction.
